(19) United States
(12) Patent Application Publication
(10) Pub. No.: US 2009/0276257 A1
(43) Pub. Date: Nov. 5, 2009

(54) System and Method for Determining and Managing Risk Associated with a Business Relationship Between an Organization and a Third Party Supplier

(75) Inventors: Stewart Draper, Matthews, NC (US); Vamsi K. Jarugumilli, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/113,708

(22) Filed: May 1, 2008

(51) Int. Cl. G06Q 10/00

(52) U.S. Cl. 705/7

(57) ABSTRACT

Aspects of this invention are directed to a method for determining and managing risk associated with a business relationship between an organization and a third party supplier. A further aspect of this invention relates to a system that allows the organization to manage risk and compliance processes. Further aspects of this invention relate to identifying a potential third party for conducting a business relationship, obtaining information about the third party relating to the risk associated with the business relationship with the third party, and generating at least one score related to the risk associated with the business relationship with the third party.

### CROSS-REFERENCE TO RELATED APPLICATIONS

This application is related to U.S. patent application Ser. Nos. 11/829,704 and 11/829,705, the contents of which are incorporated herein in their entirety.

### BACKGROUND

Many organizations, such as corporations, businesses, banks, etc. encounter threats which arise from a variety of sources, both internal and external to the organization. A threat is merely anything that could harm an asset, that is, anything of value that is desired to be protected. Threats to an organization may pertain to any type of activity related to the organization and may range from computer threats to physical threats to financial threats, etc. A vulnerability is a deficiency that leaves an asset open to harm and creates a particular amount of risk. Risks are associated with every aspect of the organization's business. For example, risks could be created from an organization's business relationships with third party suppliers, threats to an organization's computer network, security of an organization's confidential information, employee impropriety, etc. These organizations have a substantial interest in managing risks in order to prevent financial losses, customer or supplier losses, goodwill deterioration, and/or shareholder losses. Therefore, these organizations need to be able to identify a risk and also have processes in place that will mitigate or limit the risk.

There are obstacles that can prevent organizations from effectively managing risk. For example, while risk management systems or compliance processes may be created and put in place by the organization to limit a certain risk, depending the on the particular situation to which a compliance process is being applied, the compliance process may be altered by the member of the organization responsible for implementing it. Alternatively, the compliance process may be only partially adhered to or not followed at all. As a result of such alterations or lack of adherence to the compliance processes, the potential risk to which these compliance processes are directed might not be mitigated. It can be difficult to identify and track when such an alteration was made or when a compliance process was not followed. Further, it can be difficult to identify which member of the organization altered the process or if that alteration was authorized. Hence, it is clear that unless the risk management and compliance processes are monitored they will not be as effective in mitigating risk.

An organization may be extremely large and its business may have a multitude of different aspects or areas, each of which may have its own particular risk and compliance processes. This lack of unity creates another obstacle to managing an organization's risk. While an organization may have a technology infrastructure which is used in monitoring and managing the risk and compliance processes, this technology infrastructure may have separate components which each relate specifically to the individual diverse aspects of the organization. For example, the organization may have one component of its technology infrastructure directed to the organization's relationships with third parties, such as vendors. Another of the organization's components could be directed to investigations of incidents related to the organization (incidents may pertain to any type of activity related to the organization and may range from violations of policy to contract violations to criminal or civil investigations to information being compromised). If these two components are separate from each other, then each must be maintained and monitored separately. In a large organization, with many different aspects of business, there may be a large number of separate components. The separate maintenance and monitoring of each of the components can be wasteful, because it could create duplication of efforts and multiple storage sites of data.

Further, having separate components within the technology infrastructure may have other drawbacks. For example, data in one component of the organization's technology infrastructure may be useful in another area of the organization's business. If the components are maintained separately, then transferring the data from one component to another would require extensive time, effort and cost. Therefore, organizations have a substantial interest in integrating data from different aspects or areas of their business.

### SUMMARY

The following disclosure is directed to a method and system for managing risk and integrating different aspects of an organization's business. In view of the background in the art (above), aspects of the invention are grounded in a realization by the inventors that it would be desirable to have a single technology infrastructure or system that spans the different aspects of an organization's business and integrates data from all aspects of the organizations business and allows the data to be shared throughout different areas of that organization's business. Further, it is desirable for that single integrated technology infrastructure or system to be able to monitor all risk management and compliance processes throughout the system to ensure they are not only adhered to, but also are up to date with federal regulations and/or industry practices or standards.

An aspect of the invention relates to a system for integrating a plurality of modules in the system so that data from any of the modules can be transferred to any of the other modules or otherwise shared throughout the system.

Another aspect of the invention relates to an integrated system that allows the organization to manage risk and compliance processes. For example, the risk and compliance processes can be monitored to ensure they are adhered to and if the processes are not followed, the system can determine any deviations from the process.

Another aspect of the invention relates to a module for managing investigations of an incident related to an organization. The investigations module is used to collect investigative information, record the analysis of that collected information and report findings. The investigation module uses a standardized method to perform these tasks, because the standardized method provides a uniform process that each investigation must follow. This uniformity is conducive for managing the risk associated with the investigation and incident, since the uniformity of the process ensures that the compliance processes are followed.

Another aspect of this invention relates to a module for quantifying risk in order to allow an organization to appropriately react to risks associated with various transactions supported by differing systems and applications.

Yet another aspect of this invention relates to a module for automatically determining a risk associated with a business relationship between an organization and a third party.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram of a general purpose digital computing environment in which certain aspects of the present invention may be implemented.

FIG. 2 is an example of a block diagram of a system that may be used to implement the processes and functions of certain aspects of the present invention;

FIG. 3 is a block diagram of a workstation and a server that may be used to implement the processes and functions of certain embodiments of the present invention;

FIG. 4 illustrates a schematic diagram of an illustrative embodiment of a system according to one aspect of the present invention;

FIG. 5A is a flow chart describing the flow of an incident management process according to an aspect of the present invention;

FIG. 5B is a chart describing the investigation process according to one aspect of this invention;

FIGS. 6A-I are examples of graphical interfaces that may be used during an investigation according to one aspect of the present invention;

FIGS. 7A-7B are a transaction risk assessment process flow diagram in accordance with at least one aspect of the present invention;

FIG. 8 is an risk assessment process in accordance with at least one aspect of the present invention;

FIG. 9 is an example flowchart illustrating questions asked and steps taken to model threats and their potential impact on a business entity in accordance with at least one aspect of the present invention;

FIG. 10 is an illustrative equation for the interaction and uses of various libraries in accordance with at least one aspect of the present invention;

FIG. 11 illustrates an example block diagram of interactions between various components in accordance with at least one aspect of the present invention;

FIG. 12 is an example flowchart illustrating a process for forecasting risk associated with a project in accordance with at least one aspect of the present invention;

FIG. 13 is an example flowchart illustrating a process for addressing business initiatives in accordance with at least one aspect of the present invention;

FIG. 14 is an example flowchart illustrating a process for rating threats in accordance with at least one aspect of the present invention;

FIG. 15 is an example flowchart illustrating a process for maintaining a control library in accordance with at least one aspect of the present invention;

FIG. 16 is an example flowchart illustrating a process for determining a relationship between a business driver and a forecasted threat in accordance with at least one aspect of the present invention; and

FIG. 17 is a block diagram of an illustrative tree identifying various components of a business driver/initiative and a forecasted threat in accordance with at least one aspect of the present invention;

FIG. 18 is an example flowchart illustrating a process for determining a risk for a business relationship;

FIGS. 19A-B are an illustrative example of one embodiment of a Supplier Profile according to an aspect of the present invention;

FIGS. 20A-B are an illustrative example of one embodiment of a Business Relationship Summary according to an aspect of the present invention;

FIGS. 21A-D are an illustrative example of one embodiment of an Assessment Summary according to an aspect of the present invention;

FIGS. 22A-C are an illustrative example of one embodiment of an Assessment according to an aspect of the present invention;

FIGS. 23A-B are an illustrative example of one embodiment of a Findings Summary according to an aspect of the present invention; and

FIGS. 24A-B are an illustrative example of one embodiment of a Question Summary according to an aspect of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

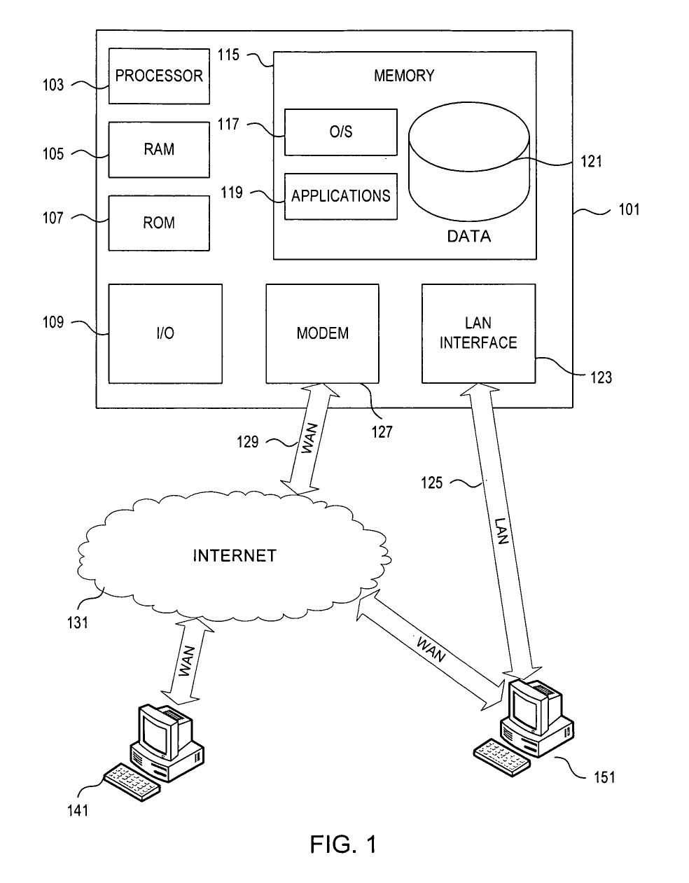

FIG. 1 illustrates a block diagram of a generic computing device 101 (e.g., a computer server) that may be used according to an illustrative embodiment of the invention. The computer server 101 may have a processor 103 for controlling overall operation of the server and its associated components, including RAM 105, ROM 107, input/output module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of account information and account holder information for the entire business, allowing interoperability between different elements of the business residing at different physical locations.

The server 110 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the server 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

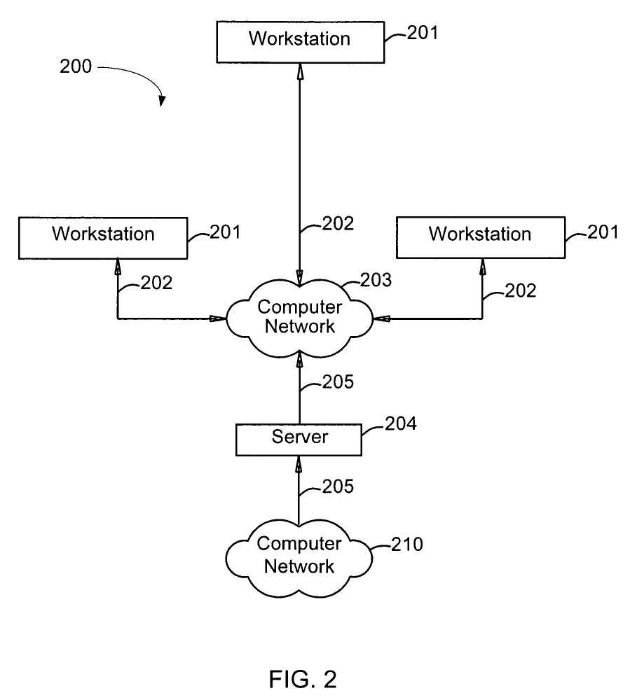

Referring to FIG. 2, an illustrative system 200 for implementing methods according to the present invention is shown. As illustrated, system 200 may include one or more workstations 201. Workstations 201 may be local or remote, and are connected by one or communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

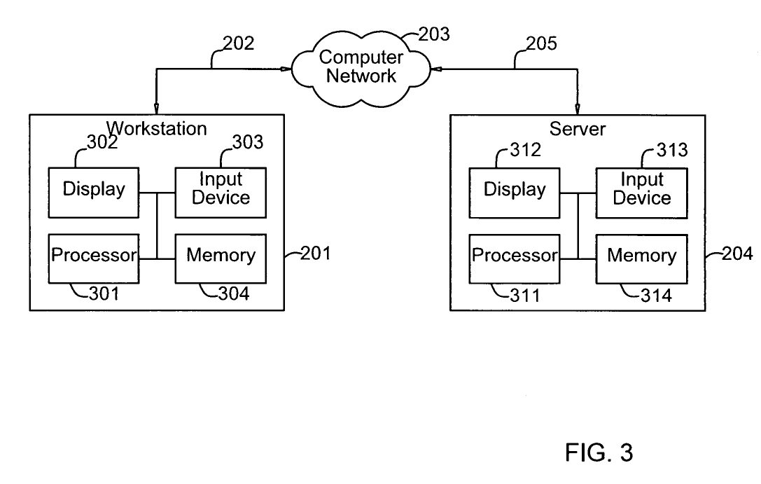

The server and one of the workstations, which are depicted in FIG. 2, are illustrated in more detail in FIG. 3. Referring to FIG. 3, workstation 201 may include processor 301, display 302, input device 303, and memory 304, which may be interconnected. In one embodiment, memory 304 may contain a storage device for storing a workstation program for controlling processor 301. Processor 801 uses the workstation program to present, on display 302, information relating to process functions to a user of workstation 201. Furthermore, input device 303 may be used to receive information associated with applications.

Server 204 may include processor 311, display 312, input device 313, and memory 314, which may be interconnected. In one embodiment, memory 314 may contain a storage device for storing transaction information relating to the transactions entered into by users implementing processes, and/or users inputting necessary information for processes, according to the invention. The storage device may further contain a server program for controlling processor 311. Processor 311 may use the server program to implement one or more of the processes according to one or more aspects of the invention. It should be noted that all references herein to processors may be understood to include multiple processors performing a portion (or all) of a single task or, alternatively, a single processor performing multiple processes.

The Integrated System

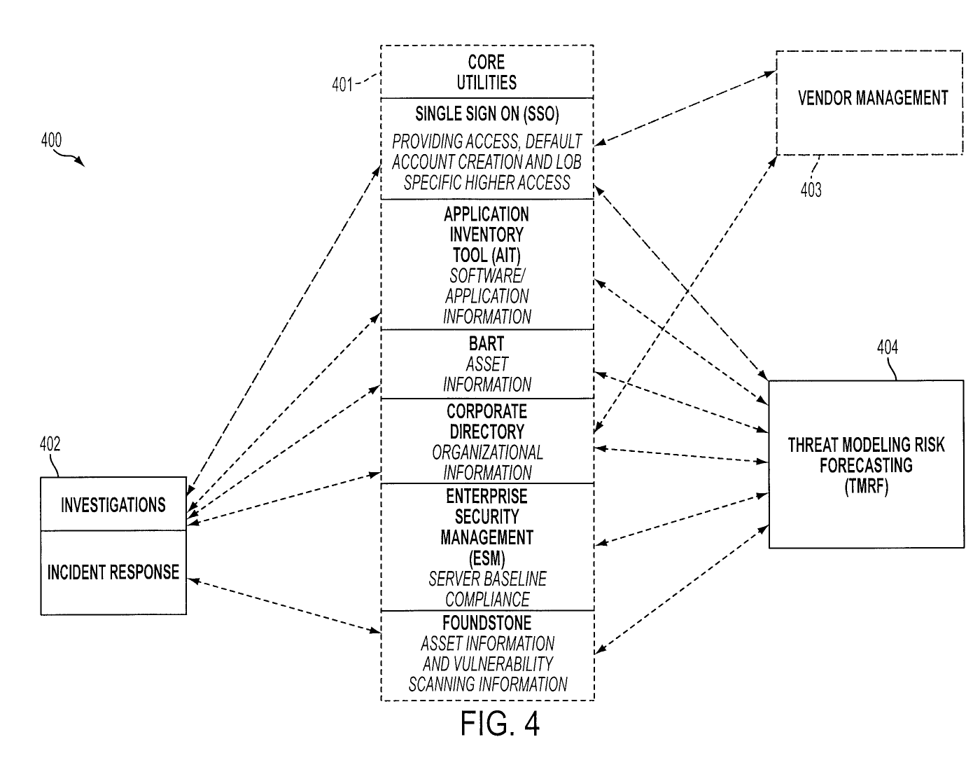

According to a particular aspect of this invention, a technology infrastructure, or system, may include a plurality of components, or modules, that each relate to different aspects, of an organization's business. For example, the system may include modules directed to: Investigations/Incident Management, Risk Analysis and Management of Third Party Business Relationships, Threat Modeling Risk Forecasting, etc. Each of these modules may include other modules therein that facilitate the functions of the overall module. Further, the modules may be integrated through a common platform, so that information can be shared between the different modules. For example, FIG. 4 illustrates a schematic diagram of a single technology infrastructure, or system, with modules directed to different aspects of an organization's business. As seen in FIG. 4, the modules are integrated through a common platform so that data can be shared between the modules. Specifically, the illustrative embodiment shown in FIG. 4 is a system 400 which includes a platform 401 that integrates an Investigations/Incident Management module 402, a Vendor Management Module 403, and a Threat Modeling Risk Forecasting 404. This embodiment is merely exemplary and other embodiments of this invention may include different modules. For example, other embodiments according to this invention could include any combination of these modules along with other modules related to other aspects of the organization's business, such as financials or engineering.

By integrating all the different aspects of the organization's business, the technology infrastructure eliminates many of the drawbacks described above that are associated with a system having separate, isolated components, such as duplication of effort, multiple storage sites of data, manual transfer of data, etc. In other words, the integration of the modules through the common platform allows data that was previously isolated in a particular module to be shared throughout the entire system. For example, in the illustrative embodiment shown in FIG. 4, a compliance process that was put in place for the Vendor Management module 403 may be applicable to other modules such as the Investigations module 402 or the Threat Modeling Risk Forecasting module 404. Under this integrated system 400, that compliance process is now available to any part of the system such as the Investigations module 402 or the Threat Modeling Risk Forecasting module 404. Alternatively, or in addition to, a compliance process that may be applicable to all or some of the modules of the system 400 may be available through the platform 401. Therefore, this integrated system significantly reduces duplication of efforts of implementing compliance processes and risk management systems.

Similarly, updating the compliance processes or risk management is now more efficient. These compliance processes and risk management strategies must be evaluated and updated periodically to remain up to date with federal regulations and industry practices. For example, an organization such as a bank in the United States is overseen by the federal government's Office of the Comptroller of the Currency (OCC) which regulates the banking industry in the United States. The OCC charters, regulates and supervises all national banking institutions. Therefore, the OCC creates standards and guidelines which each bank must follow. For instance, the OCC expects the board of directors of a banking institution to properly oversee and manage all of the banking institution's business relationships with third parties. As the standards and guidelines are updated by the OCC, each bank must also update their compliance processes in order to meet the standards and guidelines. Of course, the bank may simply create new compliance processes or update their existing compliance processes on their own initiative too. Under this integrated system, a compliance process that is applicable to several of the modules may be updated once and applied to all the modules. Therefore, this integrated system significantly reduces duplication of efforts in updating compliance processes and risk management systems.

A further advantage of the integrated system is that the compliance processes can be more easily and efficiently monitored. For example, by integrating the modules of the system, the data from the modules can be transferred throughout the system. Therefore, compliance processes for all the modules can be managed under a single system 400. This eliminates the need to separately manage and monitor each individual module's compliance processes. For example, each of the modules may include systems to record any of the information inserted into the module. This information would include information input to satisfy the compliance processes for that particular area of business. The integrated system could include a method which alerts a member of the organization responsible for monitoring compliance processes, that a compliance process has been altered or not completed at all. For example, in the Investigations module (described below), if a field of the recorded data for satisfying the compliance process has been left unfilled, the compliance monitor may be alerted to such a omission and appropriate action can be taken. For example, the compliance monitor can use the integrated system to determine the lead investigator and contact them to ensure that the omission was appropriate or authorized. Therefore, the integrated system ensures that the compliance processes for each module are effectively implemented without having to separately monitor each individual module. Similarly, in the Vendor Management module (also described below) if a vendor is approved for a business relationship (e.g. a contract) without meeting particular requirements of the compliance process, such as the vendor achieving a particular score in the assessment, then the compliance monitor may be alerted to such a change and appropriate action can be taken. For example, the compliance monitor can use the integrated system to determine who authorized the business relationship and contact them to ensure that the approval was authorized by an appropriate person or that the score was justifiable for a particular vendor or situation. Further, in the Threat Management and Risk Forecasting module (also described below), if a particular project is approved despite a risk forecast for the project be unacceptable, then the compliance monitor may be alerted to such a change and appropriate action can be taken. For example, the monitor can use the integrated system to determine that the project approval was authorized by an appropriate person. A further advantage of the integrated system is that trending can be performed for risk analysis.

A further advantage of the integrated system is that data transferred or shared throughout the system. For example, information input into a particular module such as the Vendor Management module 403 may be useful in another module such as the Investigations module 402. In other words, if an investigation was ongoing regarding an incident with a particular vendor, then information such as contact information regarding the subject of the investigation may be already contained with the vendor profile information within the Vendor Management module 403. Such information would be useful in the investigation and, therefore, should be recorded in the investigation file created in the Investigations module. If these two components were separate and isolated from each other, then the transfer of data from the Vendor Management module 403 to the Investigations module 402 would have to be done via manual intervention. This would be wasteful, create duplication of effort and multiple storage sites of data. By integrating the modules through a common platform, the data could be transferred throughout the system.

Investigations/Incident Management Module

According to a particular embodiment of this invention, the system can include a module directed to managing investigations of an incident related to an organization. The investigations module is used to collect investigative information, record the analysis of that collected information and report findings. The investigation module uses a standardized method to perform these tasks, because the standardized method provides a uniform process that each investigation must follow. This uniformity is conducive for managing the risk associated with the investigation and incident, since the uniformity of the process ensures that the compliance processes are followed. Further, the uniformity is also useful in case management reporting, standardizing workflow and tracking changes and updates. Another advantage of the investigation module is that it creates a record about the incident and/or investigation for audit requirements. Another advantage of the investigation module is that it allows for the status of investigation or any information related to the investigation to be located and monitored quickly and easily. As will be discussed in detail below, the investigations module will include, or at least be in communication with, other modules related to the investigations.

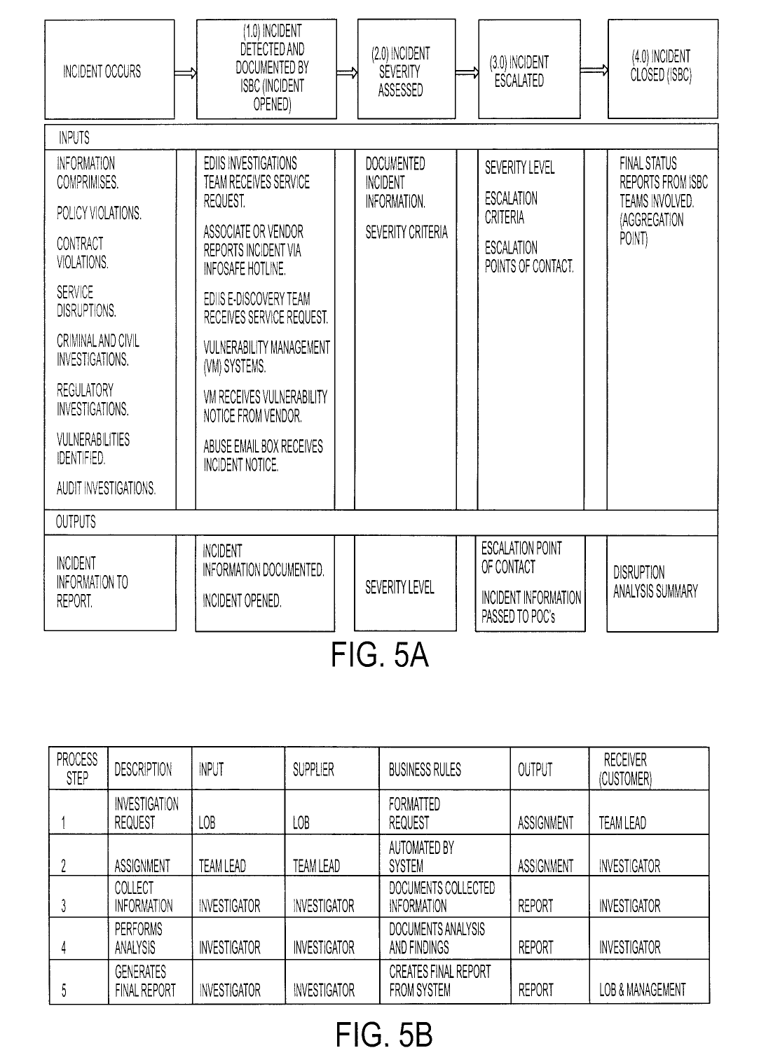

The investigations that are conducted using the Investigations module can be initiated in several ways. First, an incident may be reported to the organization. The incident may be reported to an Incident Response Group of the organization by a member of the organization or it may be reported by a party external to the organization, such as a vendor or a customer. Once the incident is reported to Incident Response Group, the Incident Response Group reviews the information about the incident to determine whether an investigation is necessary. If it is warranted, an investigation is opened and the information is forwarded to the Investigations team. FIG. 5A shows a high level process flow of the management of the reported incidents. As seen in FIG. 5A, the incident may be reported in a variety of ways. For example, the Investigations team may receive a service request. Alternatively, the incident may be reported by a vendor or associate of the organization through a “hotline” for receiving investigation requests either via email or telephone (e.g. as seen in FIG. 5A, the Infosafe module is a “hotline” for receiving incident reports). FIG. 5A also shows other methods through which the incident may be reported. Further, as seen in FIG. 5A, once the incident occurs, the first step of the process is to document or record the incident. After the incident has been documented, the next step is to assess the severity of the incident. Thereafter, the incident is escalated (which may include forwarding the information to the Investigations team for an investigation) and the final step is to close the incident.

It is noted that incidents may pertain to any type of activity related to the organization. For example, the incident may include: information being compromised (e.g. customer or employee personal information such as a social security number or organizational information such as financial data, internal policies or trade secret information), violations of policy, service disruptions, contract violations, criminal or civil investigations (e.g. theft or destruction of an organization's property such as theft of an employee's laptop computer or alternatively employee impropriety, such as harassment), regulatory investigations, identification of vulnerabilities.

Another way the investigation could be initiated is at the specific request of an entity within the organization (e.g. a Line Of Business [LOB] of the organization) or member of the organization (e.g. a manager requesting an investigation of an employee). FIG. 5B shows a high level process flow of the management of the investigation wherein the request has been requested in this manner (it is noted that an investigation initiated through Incident Response Group described above would progress in a similar manner). As seen in FIG. 5B, once the request has been received, the investigation is assigned to a team leader to conduct the investigation. Then the processes of collecting information, performing analysis and generating a final report are performed. Therefore, regardless of how the investigation is initiated, once it has been determined that the investigation will be conducted, the investigation will follow a standardized process through which information is collected, analyzed and reported. This standardized method of performing these processes will be described below with reference to the Investigations module.

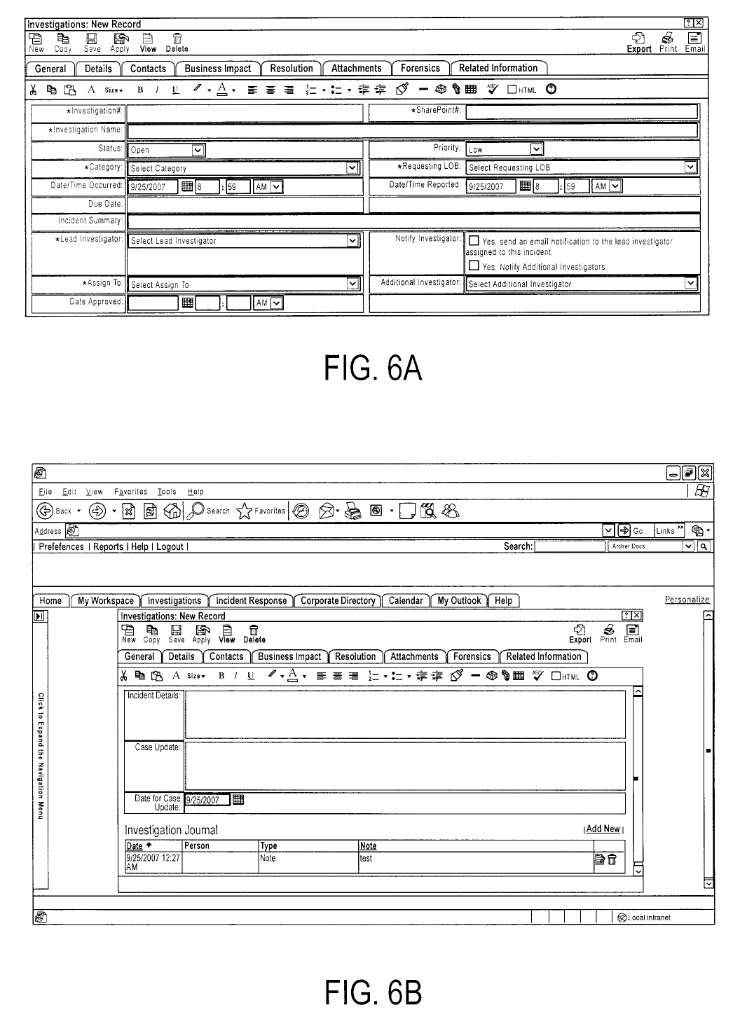

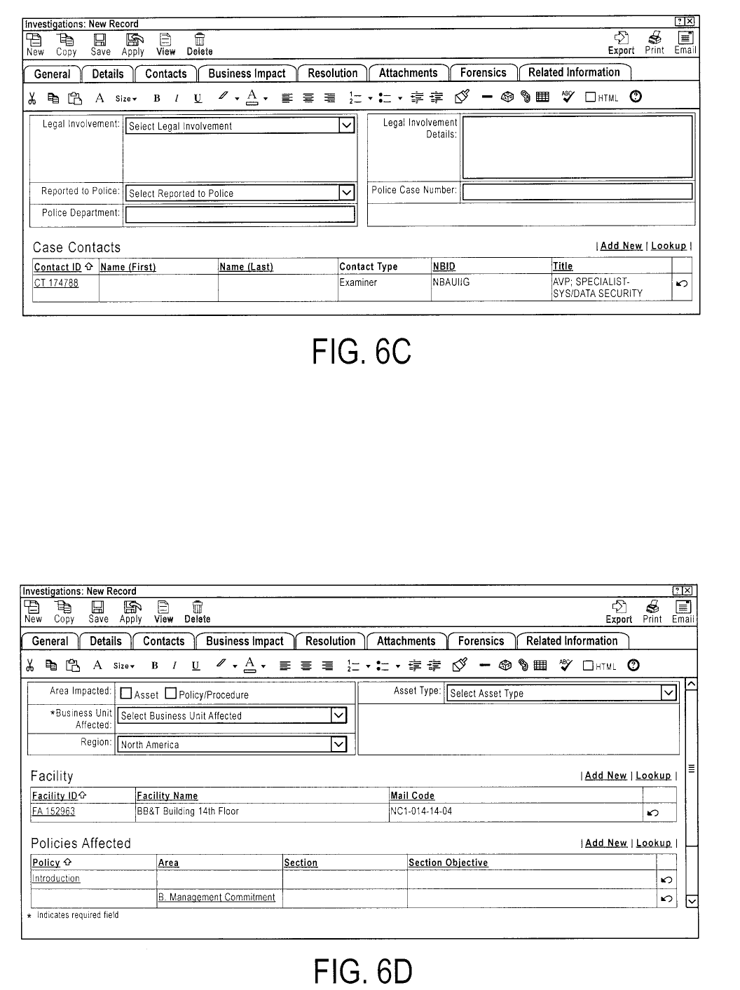

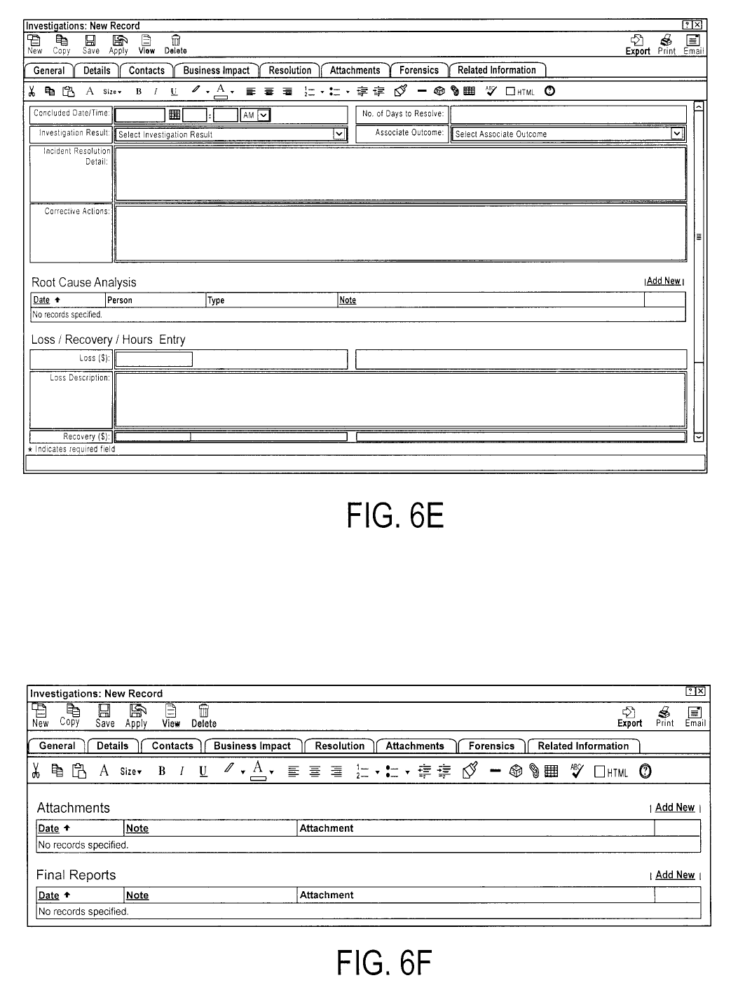

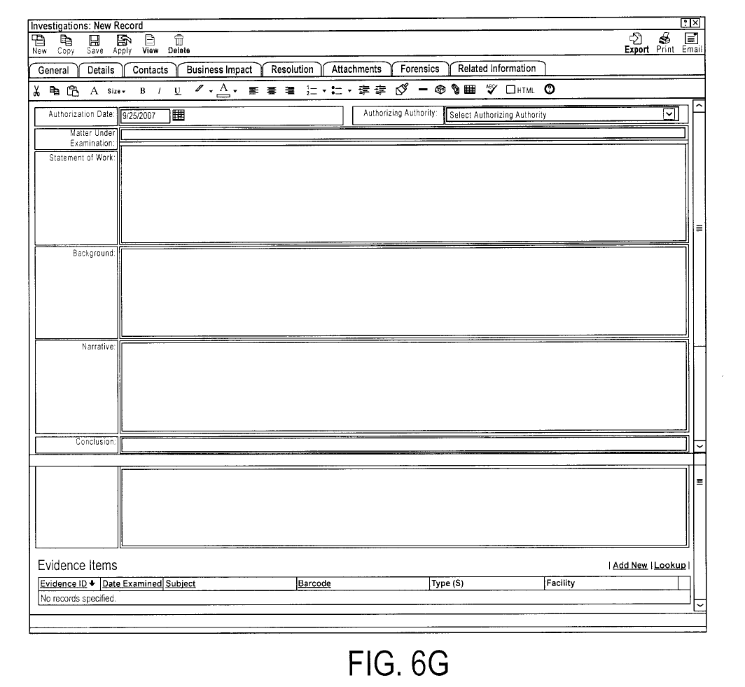

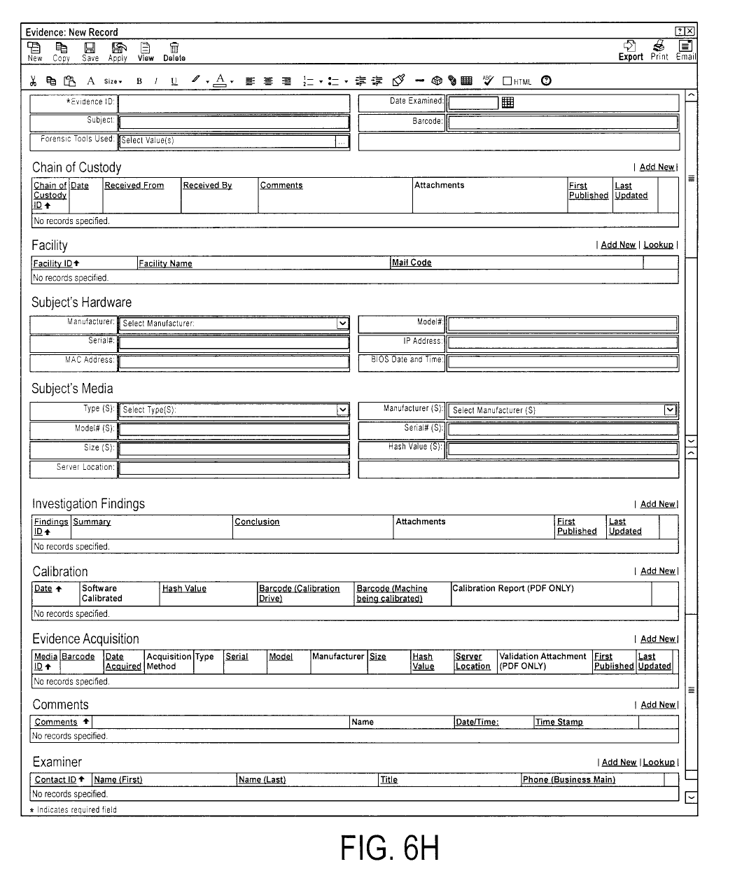

The first step in the standardized method is for the basic investigation information to be documented in the Investigations module. Therefore, the Investigations module may include another section, a General Case Management/Information section that is used to create the case for the investigation. The General Case Management/Information section may store basic information about the investigation, such as the investigation name, a brief summary of the incident, current status of the investigation, certain dates around the investigation, the priority of the investigation, the group within the organization (e.g. LOB) requesting the investigation, etc. As shown in FIG. 6A, the General Case Management/Information section may include a graphical interface with fields in which a user will input such information.

Further, the Investigations module may include another section, a Details section which may store more detailed information about the case, including updates about the case, and an investigative journal that allows the user to keep a chronological activity log. As shown in FIG. 6B, the Details section may include a graphical interface with fields in which a user will input such detailed information

Further, the Investigations module may include yet another section, the Contacts section, which may store contact information about the investigation. In this embodiment, the term “contacts” includes anyone who was involved with either the incident or investigation. For example, it may include information on the subject of the investigation. It may also include information for people conducting the investigation, such as the lead investigator. This contact information can be linked to other modules within the investigation module such as the Forensics/Evidence module (described below). The Contacts section may also include information on whether the incident has been reported to the police or if there is any legal involvement in the case. As seen in FIG. 6C, the Contacts section, has an embedded module, GIPBC Contacts, that includes a graphical interface with fields for a user to insert such contacts information about the investigation.

Further, the Investigations module may include yet another section, the Business Impact section, which may store information regarding any impact the incident or investigation has had on the organization. This information could include which business area of the organization may have been affected, including the specific facilities affected, an embedded module called Facilities, the type of assets affected corporate policies that may have been affected. Further, this information could also include any of the organization's policies, an embedded module called Policy Management, that may have been affected by the incident. As seen in FIG. 6D, the Business Impact section may include a graphical interface with fields for the user to insert such information.

Further, the Investigations module may include yet another section, the Resolution section, which may store information regarding the resolution of the investigation. This information could include the date the investigation concluded, the number of days to resolve, the result of the investigation, a detailed summary of the resolution, corrective actions to be taken, the root cause analysis, the monetary loss associated with the incident and investigation, hours spent recovering data pertaining to a data loss associated with an investigation, cause of the data loss, etc. As seen in FIG. 6E, the Resolutions section may include a graphical interface with fields for the user to insert such information.

Further, the Investigations module may include yet another section, the attachments section. As seen in FIG. 6F, the attachments section may include a graphical interface for a user to attach external files associated with the investigation.

Further, the Investigations module may include yet another section, the Forensics/Evidence section, which may store information regarding any evidence gathered and forensic activity related to the investigation. This information may include the evidence that was collected (e.g. serial number of a hard drive), where the evidence was collected (e.g. which facility within the organization the evidence was located), how the evidence was examined, who performed the examination of the evidence, conclusions of the examiner based on the examination, etc. As seen in FIG. 6G, the Forensics/Evidence section may include a graphical interface with fields for the user to insert such information regarding the evidence collected and the forensic examination on the evidence. Further, as shown in FIG. 6H, the Forensics/Evidence section may include a separate graphical interface, an embedded module called Evidence, for collecting additional information for each piece of evidence in the investigation. In this graphical interface, information regarding the piece of evidence's chain of custody, the calibration of the examination computer, how the evidence was acquired, etc. may be input.

Still further, the investigations module may include yet another section, the Related Information section, which may store information regarding any items in the system that are related to the investigation. Such information may include another investigation related to the present investigation, how the investigation was requested (e.g. if the investigation was requested through an incident reported through the Infosafe module, or alternatively if a supervisor or LOB requested the investigation), details of why the investigation was requested, etc. As seen in FIG. 6I, the Related Information section may include a graphical interface to other modules with fields for the user to insert such information.

The above described modules provide a standardized method for conducting and recording an investigation. In and of itself, the Investigations module and its standardized method create a sustainable mechanism for managing risk and compliance processes. By following this standardized method and recording the data, a record is generated that will describe the investigation information for auditing, monitoring or tracking purposes. Further, the Investigations module and its standardized method may be used in conjunction with a compliance process for ensuring that any risk associated with the incident or investigation is minimized. For example, the Contacts section provides an opportunity to record whether there has been any police involvement or legal advice sought. Determining whether either of these situations is appropriate and the person who made these determinations can be recorded. Failing to make these determinations and also failing to record such information may be a violation of a compliance procedure intended to minimize risk or liability associated with the incident. Therefore, if these fields are not completed, the system may signal a compliance monitor that a compliance process has been violated. Then the compliance monitor may take appropriate action to ensure that the risk is minimized. This system will also provide the opportunity for the compliance monitor to track the person who violated the compliance process or authorized the violation, since such information will be listed in the Contacts section. While this is merely an example of how the Investigation module and integrated system may be used to ensure compliance processes are followed and risk is minimized, countless other methods may be used also. For example, if the resolution of the case is not completed within a certain time period, the integrated system may alert the compliance monitor. If the chain of custody for a particular piece of evidence is not sequential or otherwise correct, the integrated system may alert the compliance monitor. If a piece of evidence of a subject of the investigation is related to another investigation, the system may recognize this and alert the compliance monitor.

Threat Modeling Risk Forecasting Module

According to a particular embodiment of this invention, the system can include a module directed to modeling threats and forecasting risks related to an organization. The Threat Modeling and Risk Forecasting module correlates current and forecasted threats to projects and initiatives factoring in current and forecasted controls. It provides an organization with a single integrated view of critical operational risk components and risk assessment data. Therefore, an organization does not have to allocate risk control resources and make strategic risk/reward decisions based upon disparate and often subjective information. Instead, the Threat Modeling and Risk Forecasting module enables an organization to proactively identify Information Security and Business Continuity (ISBC) threats related to a project or strategic initiative within a line of business and the controls associated with these threats.

The Threat Modeling and Risk Forecasting module quantifies risk in order to allow an organization to appropriately react to risks associated with various transactions supported by differing systems and applications. Furthermore, because the risk metrics can change as threats, countermeasures, and controls change or evolve over time, the Threat Modeling and Risk Forecasting module creates processes to measure that risk in a consistent and standardized way and wherein the processes are also able to adapt to changes in risk metrics and associated parameters.

The Threat Modeling and Risk Forecasting module may include a risk assessment process which provides a consistent, substantially standardized, scalable and re-usable process to measure a level of risk associated with one or more specific transactions within applications. The process may be generic and may be re-used by companies in various fields with different transactions, different applications, and even different countermeasures, while still providing risk scores that may be used to support related decisions and strategy.

Various embodiments of the risk assessment process in accordance with one or more aspects of the present invention may identify and quantify the level of risk, such as by a transaction-based analysis, associated with a customer, or other suitable user, interfacing with a product and/or service. The process may identify security threats and access current available controls associated with a particular threat. The process may further forecast, in an effort to determine, the controls' effectiveness in protecting against the threat.

In one embodiment of the invention, the process may assess customer-facing transactions. A first step of the process may identify the total risk level of the transactions. A second step may identify the transactions' controls. Another step may calculate the residual risk level of the transactions following the implementation of the controls.

Such a process preferably provides knowledge of where and which controls to implement. Particularly, the process enables the controls to be installed at the transaction level of the products/services and, thereby, to be closely tailored to the characteristics of the risk.

One problem that a method according to the invention may solve is as follows. Many organizations need ways to understand and manage the risk associated with the services they provide to customers, partners, and employees. A generic risk assessment process according to the invention may be used by any organization, financial services or other that needs to perform repeatable and scalable risk assessments. One particular embodiment of a risk assessment process according to the invention may enable adherence to the FFIEC (Federal Financial Institutions Examination Council) Authentication Guidance.

The guidance, issued on Oct. 12, 2005, updates the FFIEC's guidance entitled Authentication in an Electronic Banking Environment issued in 2001. It addresses the need for risk based assessments, customer awareness, and enhanced security measures to authenticate customers using Internet-based products and services that process high risk transactions involving access to customer information or the movement of funds to other parties. One such illustrative transaction which requires authentication is an ATM (Automated Teller Machine)-based transaction. A method according to the invention may be applied to analyze the risks associated with such a transaction. Additionally, methods according to the invention may be implemented in any suitable transaction-based risk analysis. Prior to FFIEC Authentication Guidance, financial institutions did not have a process to perform products/services transaction risk assessments.

The process according to one or more aspects of the invention provides a substantially consistent way to measure transaction risk in any application/product in any line of business across an enterprise. In another embodiment of the invention, the systems and methods may be applied to transaction-based analysis of factors other than risks. One such factor may be quality assurance. Accordingly, the processes disclosed herein may be applied to quantification of measures of quality assurance such as formulation of a quality assurance index, threats to quality assurance, controls of such threats and residual effects of the threats on the quality assurance index following the implementation of the controls on the threats.

One aspect of a process according to one ore more aspects the invention is a risk assessment methodology. Specifically, the process may identify customers facing services/applications that may be implicated by heightened risk, identify transactions, identify threats, identify controls that may be used to response to the threats, and measure the effectiveness of controls on transactions against threats.

Another aspect of the process according to the invention relates to providing a multi-layered control environment. Such layers may include identified front door controls, transaction controls, back end controls, and/or associate controls.

Yet another aspect of the invention relates to the various inputs for risk assessment. A risk assessment process according to one or more aspects of the invention takes a broad array of inputs. The process may use the broad array of inputs to assess risk at a much more granular level, e.g., in one embodiment, risk may be assessed at the level of the individual transactions.

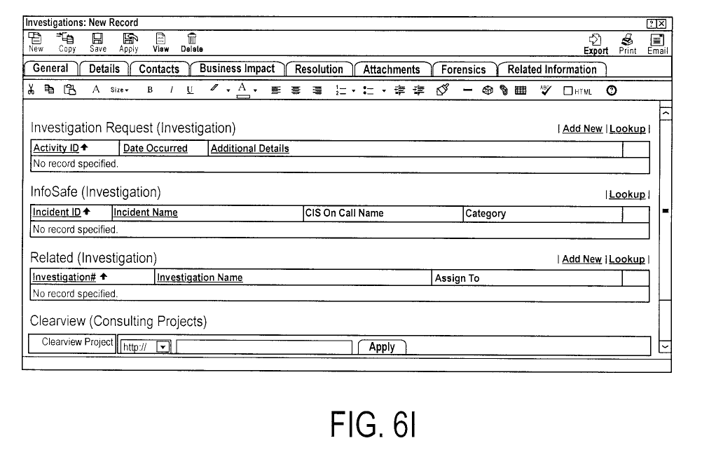

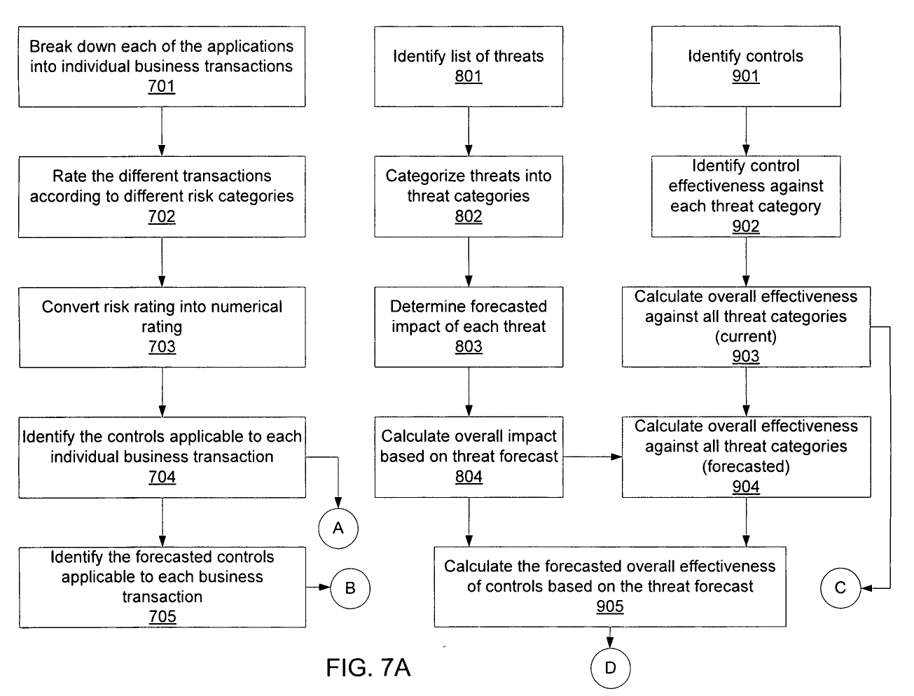

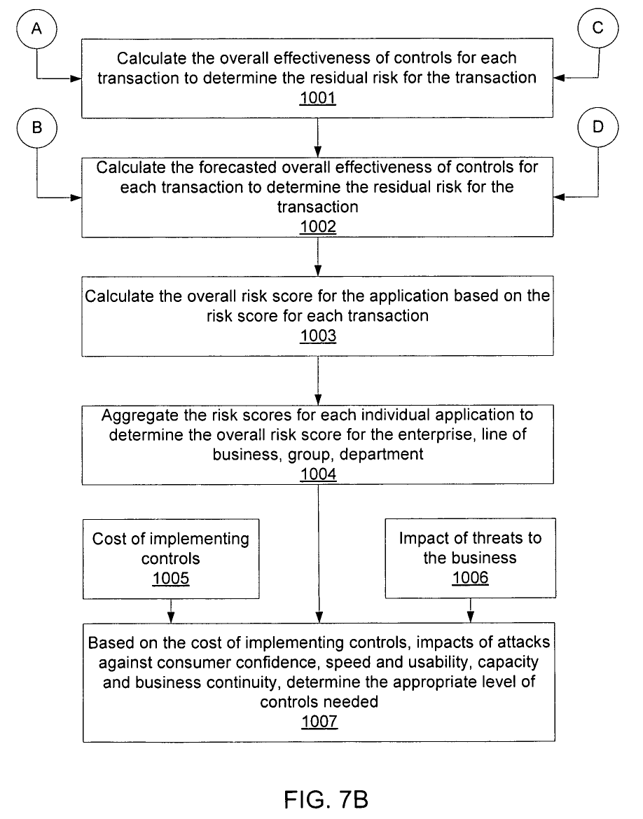

FIGS. 7A-7B show a transaction risk assessment process flow diagram according to one or more aspects of the invention. At step 701, each of the applications is broken down into its individual business transactions. At step 702, the different individual transactions are rated according to different risk categories such as transaction risk, reputation risk, and financial liability risk. Proceeding to step 703, the risk ratings are converted into a numerical rating with a value that may be used for numeric ranking.

Moving to step 704, the controls applicable to each individual business transaction are identified. From step 704, two paths may be followed according to the invention. A first path may identify the forecasted/projected controls applicable to each business transaction, as shown in step 705. A second path may calculate the overall effectiveness of controls for each transaction to determine the residual risk for the transaction, as shown in step 1001 in FIG. 7B.

From step 705, the system may calculate the forecasted overall effectiveness of control to determine the residual risk for the transaction as shown in step 1002 in FIG. 7B. An alternative path to step 705 may be taken through step 1001.

Returning to FIG. 7A, at step 801, a list of threats are identified for each type of transaction. At step 802, the identified threats are categorized into threat categories. The impact of each threat may be forecasted in step 803. Proceeding to step 804, an overall impact is calculated based on the previously-determined threat forecast.

Thereafter, in step 905, the forecasted overall effectiveness of controls based on the threat forecast may be calculated. In another path from step 804, at step 904, an overall effectiveness against all of the forecasted threat categories may be calculated.

At step 901, controls may be identified that may be used to deal with the threat different types of threat categories. Moving to step 902, the control effectiveness against each threat category, and/or each individual threat, may be identified.

At step 903, the overall effectiveness against all current threat categories may be calculated. In the illustrative example, two paths are shown as available from step 903. First, at step 904, the overall effectiveness against the forecasted threat categories may be calculated as described above. Additionally, another path exists directly from step 903 to step 1001, shown in FIG. 7B, where the overall effectiveness of controls for each transaction may be calculated to determine the residual risk for the transaction.

From step 905, the process shows that at least one of two paths may be followed. The first path is to step 1001, where the overall effectiveness of controls for each transaction may be calculated to determine the residual risk for the transaction. The second path is to step 1002, where the forecasted overall effectiveness of controls may be calculated to determine the residual risk for the transaction.

From step 1002, the process moves to step 1003, where the overall risk score for the application, which may include multiple applications, may be calculated based on the risk scores for each transaction. The path from step 1003 leads to step 1004, where the risk scores for each individual application may be aggregated to determine the overall risk score for the enterprise as a whole, the line of business within the enterprise, or some small sub-entity within a particular line of business.

Step 1007 follows from step 1004. Additional inputs to step 1007 are from steps 1005 and 1006. At step 1005, the cost of implementing the various one or more controls of the transaction is accounted for in the determination in step 1007. At step 1006, the impact of the threats to the business is accounted for in the determination in step 1007. The impact in step 1006 may include the impact of the threat(s) on consumer confidence, performance and usability, capacity and business continuity, cross channel, regulatory impact, operational impact, credit impact, and market impact. Proceeding to step 1007, in response to the inputs from steps 1005 and 1006, the appropriate level of controls needed based on the cost of implementing controls and the impacts of attack against consumer confidence, speed and usability, and capacity and business continuity may be determined.

It should be noted that the flow chart in FIGS. 7A-7B is illustrative and, unless otherwise specified, the order of the steps is not necessarily binding on the invention. Accordingly, the steps may be performed in an order or sequence other than as shown without departing from the spirit and nature of the invention.

Furthermore, certain methods according to the invention may be sub-methods of the entire method shown in FIGS. 7A-7B. As such, fewer than all the steps may be claimed in the claims which follow this specification without departing from the spirit and nature of the invention.

The following is an illustrative implementation of a method according to the invention. It should be understood that the order of the following steps is but one order of steps according to the invention, and other orders of steps are possible according to the invention.

1. The customer facing applications/services for categorization are extracted by an Application Inventory Tool (AIT) (the application criteria for Risk Assessment is a field in the AIT). This inventory may be performed according to a line of business (LOB) or some other sub-entity, within an enterprise.

2. The LOB's identified customer-facing applications/services are reported to the Line of Business Application Owners (LOB) contact name(s) listed in the AIT.

3. The Line of Business Application Owners (LOB) and Technical Support are requested to identify the customer-facing applications' transactions authentication controls and to rank the risk level (High, Medium, Low) for the transaction's transaction, reputation and financial risks.

4. The LOB and Technical Support complete and submit the transaction Data Collection Form to be assessed.

5. The transaction's total risk, e.g., percent of risk relative to the risk associated with other transactions or independently from other transactions, using the results of the risk level ranking is calculated and the authentication controls category, e.g., front (pre-transaction), transaction, and backend (post-transaction), is determined.

6. The transactions' residual risk scores are calculated using the information provided by a threat management and risk forecasting process, as disclosed in more detail below in the portion of the specification corresponding to FIGS. 6-17.

7. The application's total residual risk score is calculated.

8. The application's risk assessment report is created and distributed to the LOB and Technical Support for validation.

9. Feedback is received and the application's total residual risk score is recalculated.

10. The risk assessment report is updated and distributed to appropriate distribution list (LOB's Information Security Officer (ISO), Senior Leadership Team (SLT) and Chief Information Officer (CIO). One purpose of such a communication is to communicate the results of the risk assessments.

11. A review meeting is scheduled to review results and determine next steps for applications with total residual risk scores above the information security approved authentication threshold.

12. A decision is made to accept the risk, LOB documents and provides information security business continuity authentication and information security personnel with decision to accept risk at this time. This decision may be flagged for review risk in 12 months.

13. Either together with, or alternatively to, step 12, a LOB may make a decision to mitigate the risk and form a mitigation workgroup to determine the appropriate available authentication controls.

14. Assuming that a line of business or other suitable sub-entity followed the path in step 13 as an alternative to accepting the risk, as shown in step 12, then the line of business may update a transaction data collection form with the planned additional authentication controls and submit for assessment to determine a new residual risk score for the application.

15. The line of business may develop the application mitigation plan to implement additional authentication controls.

In one further embodiment of the invention, a process may provide at pre-determined intervals, such as yearly, new authentication controls and updates to already-existing authentication controls. One embodiment of such a process may be instituted using the threat management and risk forecasting system described below. Such updates may also include the percent of effectiveness of the controls against the threats to be used in the risk assessment process according to the invention.

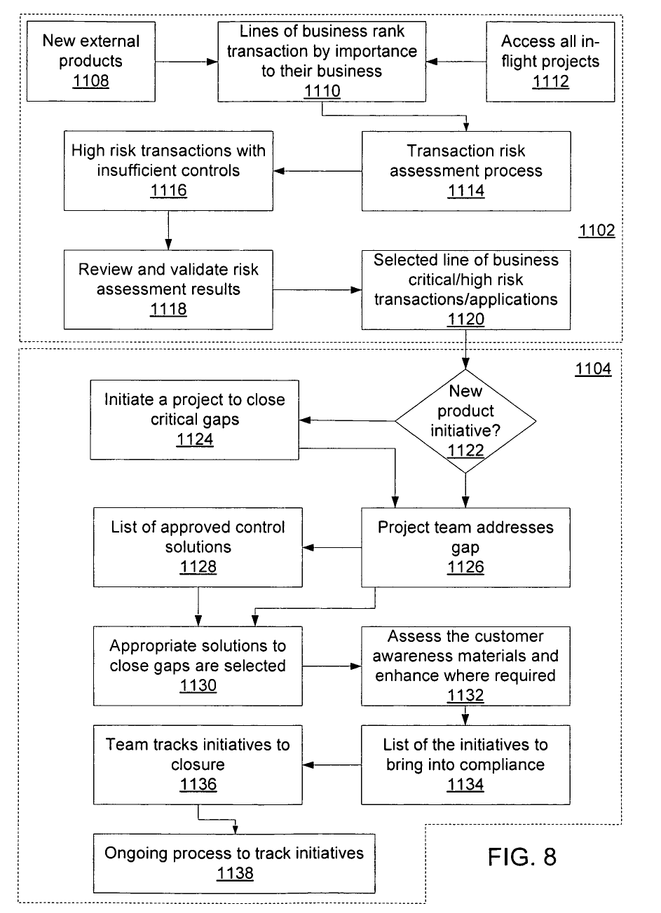

FIG. 8 is an authentication risk assessment process according to one or more aspects of the invention. FIG. 8 preferably includes two sub-parts. First, FIG. 8 includes a flow diagram illustrating an authentication risk assessment process. The process includes two branches, a risk assessment branch 1102 and an authentication risk gap closure/update customer awareness branch 1104.

Risk assessment branch includes an identification or other determination of new external product initiatives at step 1108. At step 1110, the lines of business, or other suitable sub-entity within an enterprise, rank the transaction by importance to their respective business. At step 1110, the ranking may rank by importance, some or all in-flight projects, as received from step 1112.

A transaction risk assessment process, such as, for example, the process shown in FIGS. 7A-7B above, or the process described below, may be implemented at step 1114. The process may be continued in order to identify high risk transactions with insufficient controls, as shown in step 1116. When such transactions have been identified, the lines of business may review and validate such risk assessment results, as shown in step 1118.

Following the review and validation, the selected line of business may determine critical/high risk transactions/applications as shown in step 1120. In such circumstances that are determined to be suited for transition to a new product initiative, as shown at step 1122, the authentication risk gap closure/update customer awareness process 1104 may be initiated.

If a new product initiative is undertaken in response to step 1122, then the LOBs can engage an ISBC (information security business continuity) consultant, an Information Security architect, LOB Tech Support, a network computing group consultant, an information security Authentication consultant, or some other consultant as shown in step 1126. Alternatively, if a new product initiative is not undertaken in response to step 1122, then the LOBs may initiate a project to close critical gaps to comply with Authentication Guidance, as shown in step 1124. Eventually, step 1124 may lead to step 1126, as described in more detail previously.

Two possible outcomes from step 1126 are shown. First, an intermediate step including identifying a list of approved control solutions, as shown in step 1128, may be implemented, or the LOBs may directly select the appropriate control solutions to close gaps and comply with the FFIEC Authentication Guidance, as shown in step 1130.

Following the selection of appropriate solutions at step 1130, the process may assess the customer awareness materials and enhance the materials where required, as shown in step 1132. This assessment may generate a list of initiatives to bring the new product into FFIEC authentication compliance, as shown in step 1134.

An authentication team may track initiatives to closure of the authentication risk gap, as shown in step 1136. Finally at step 1138, a possible enhancement of the process may occur where an ongoing process may be implemented to track initiatives following the introduction of a new initiative and/or product.

One or more aspects of the present invention are directed to a model/tool that enables an organization to proactively identify information security and business continuity (ISBC) threats related to a project or strategic initiative within a line of business and the controls associated with these threats. In addition, the effectiveness of these controls is provided to allow the organization to properly anticipate the risk associated with that project or strategic initiative. Such information then enables the organization to make appropriate resource allocation decisions to mitigate these residual risks by implementing new controls and/or changing elements of the strategic initiative. The tool may also incorporate other risk factors, such as supplier compliance to security practices and contractual obligations, regulatory compliance, etc., in calculating residual risk for an initiative or project. All these factors may be forecasted for residual risk reporting over a predetermined period, such as an eighteen month horizon, for the organization to make appropriate planning decisions.

Many observations, audits, vulnerability assessments, risk assessments, etc. surface a large number of risks in the current environment. As these risks are surfaced, lines of businesses are challenged with determining how to respond to the risks identified. Challenges include determining how to best prioritize identified risks and how to load balance resources to respond. Additionally, knowing that not all risks can be controlled or optimized there is limited strategy currently available that assists with forward projection of risk.

What is needed is a system and method that enables an organization to proactively identify Information Security and Business Continuity (ISBC) threats related to a project or strategic initiative within a line of business and the controls associated with these threats.

Aspects of the present invention may utilize a standardized taxonomy, e.g., classification system, to decompose threats and initiatives which are correlated to each other to identify critical dependencies/vulnerabilities. Controls may act upon threats to mitigate the threats impact. For example, anti-virus software on a computer mitigates the threats posed by computer viruses. The system may classify all the major ISBC controls at the organization based on their ability to mitigate threats.

Aspects of the present invention provide a consistent and robust model for derivation of residual risk using the correlation of business requirements, threats, controls and other risk factors, e.g., business continuity, supplier, compliance, etc. The resultant residual risk enables management to make appropriate plans to mitigate risks and obtain a profile of the current state and forecast the anticipated changes in the correlated values. The ability to track against a baseline provides the opportunity to either reduce the residual risk or mitigate further increases.

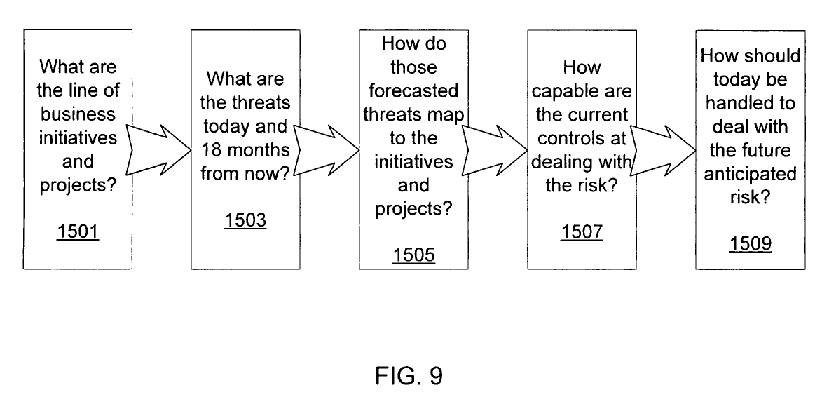

FIG. 9 is an example flowchart illustrating questions asked and steps taken to model threats and their potential impact on a business entity in accordance with at least one aspect of the present invention. With respect to the question of what are the line of business initiatives and projects posed in step 1501, line of business/business unit strategic initiatives are identified and a Hoshin plan is implemented to support the initiatives and projects. The basic premise behind a Hoshin plan is that the best way to obtain the desired result is to ensure that all employees in an organization understand the long-range direction and that they are working according to a linked plan to make the vision a reality. The second aspect of the plan is that there are fundamental process measures which must be monitored to assure the continuous improvement of the organization's key business processes. In essence, all are heading in the same direction with a sense of control. Further in response to the question posed in step 1501, a project is defined to accomplish the identified strategic initiative, and information security and business continuity become involved.

With respect to the question of what are the threats today and in eighteen months from today posed step 1503, a process is employed for identification of potential threats to the organization. Identification is conducted by sourcing of data and opinions from diverse threat knowledgeable sources. All source data is analyzed to create a threat profile for respective projects and quantitative and qualitative predictive analysis is used to create a rolling eighteen month forecast for each threat. With respect to the question of how do the forecasted threats map to the initiatives and projects posed step 1505, the strategic initiatives and projects are rated based upon the likely threats that may apply and the threats are profiled and forecasted independent of any vulnerabilities.

With respect to the question of how capable are the current controls at dealing with the risk posed step 1507, the current controls of the system are identified and specific controls are correlated to specific threats. The mitigating impact of the controls and the threats, e.g., the strength of the control, is then determined and the maturity of the controls is assessed. The future state of the controls is also forecasted. Finally, with respect to the question of how should today be handled to deal with the future anticipated risk posed in step 1509, the current and forecasted state of each threat is ranked over a rolling eighteen month horizon. Business portfolio category ratings are assessed using the current and forecasted residual threat states, and the ranking of current and future business portfolio residual impact is evaluated as a basis for resource allocation.

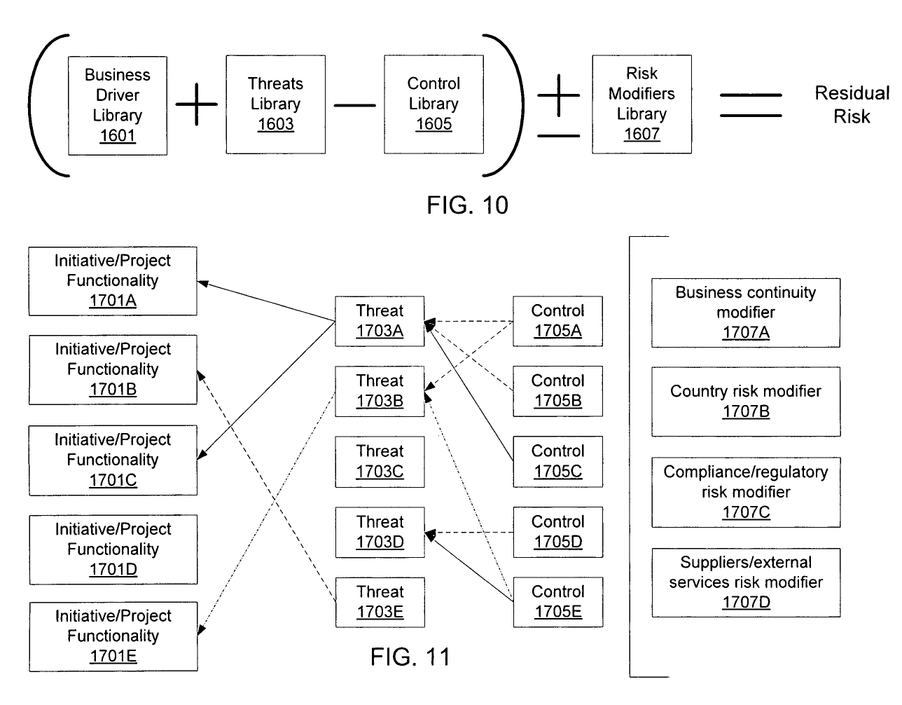

FIG. 10 is an illustrative equation for the interaction and uses of various libraries in accordance with at least one aspect of the present invention. One or more aspects of the present invention utilize various libraries of data with respect to different components of an equation to determine the residual risk associated with an initiative and project. Ranked threats in a library 1603 affecting business initiatives in a library 1601 are offset by controls for threats stored in a library 1605 and are further affected by risk modifiers maintained in a library 1607. The remaining risk amounts to residual risk that should be addressed. A business driver library 1601 may include strategic plans and/or Hoshin objectives that drive long term and tactical business initiatives. Risk profiles for these initiatives may be included in the overall model to support risk forecasting. The business driver library 1601 accounts for the vulnerabilities of the overall risk equation.

A current and emerging threats library 1603 may include operational asset data combined with current and emerging threat information to create vulnerability and risk profiles. Industry threat information updates may be captured to create updated threat profiles. The current and emerging threats library 1603 accounts for the threats of the overall risk equation. A mitigation and controls library 1605 maintains current environment profiles, where risk mitigation efforts are evaluated, modified, and incorporated as the status of the efforts change. Existing controls may be monitored for effectiveness, and any decrease in performance may be reflected back into the current environment profile. The mitigation and controls library 1605 accounts for the countermeasures or likelihood of the overall risk equation.

Finally, a risk modifiers library 1607 may include instances where a risk exposure level is not directly tied to a particular line of business. Such instances may be addressed by either applying a standard adjustment to all exposed areas or by allocating proportions of risk to the business based upon its' activity. Examples of these modifiers include the business continuity impact, the country impact, compliance/regulatory, and suppliers/external services. Examples of business continuity impact include a business impact analysis, business continuity threats, such as weather, building, geology or other natural threats and social disorder, intentional, and other man-made threats, line of business recovery plans, and line of business readiness. Examples of country impact include the countries in which the initiative will occur, potential regional impact within the country, and interaction between the countries in the initiative. Examples of compliance/regulation include any significant compliance element impacting an initiative, previous regulatory loss experiences, and utilization of compliance tracking scores. Examples of suppliers/external services include external suppliers used or an initiative, an assessment of reliance on a supplier for functionality, and utilization of vendor/supplier tracking scores.

FIG. 11 illustrates an example block diagram of interactions between various components in accordance with at least one aspect of the present invention. As illustrated, various initiative/project functionalities 1701A-1701E may be affected by one or more threats 1703A-1703E with varying degrees of impact on the initiative/project functionalities 1701A-1701E. In the illustrative example shown in FIG. 11, the solid black arrows from the threats 1703 to the functionalities 1701 illustrate a high impact, the dashed line arrow illustrates a moderate impact, and the dashed and dotted line arrow illustrates a low impact.

Controls 1705A-1705E offset the affects of threats 1703 on the functionalities 1701. In the illustrative example shown, the solid black arrows from the controls 1705 to the threats 1703 illustrate a high effectiveness on the threat 1703 by the control 1705, the dashed line arrow illustrates a moderate effectiveness, and the dashed and dotted line arrow illustrates a low effectiveness. Modifiers 1707A-1707D illustrates various risk modifiers that may have positive or negative impacts on increasing or reducing residual risk when applied to one or more of the components 1701A-1705E in FIG. 11.

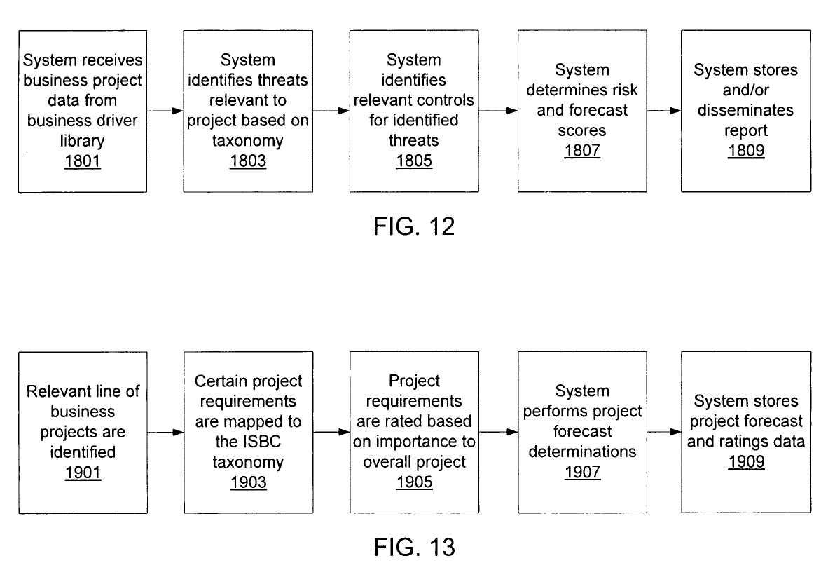

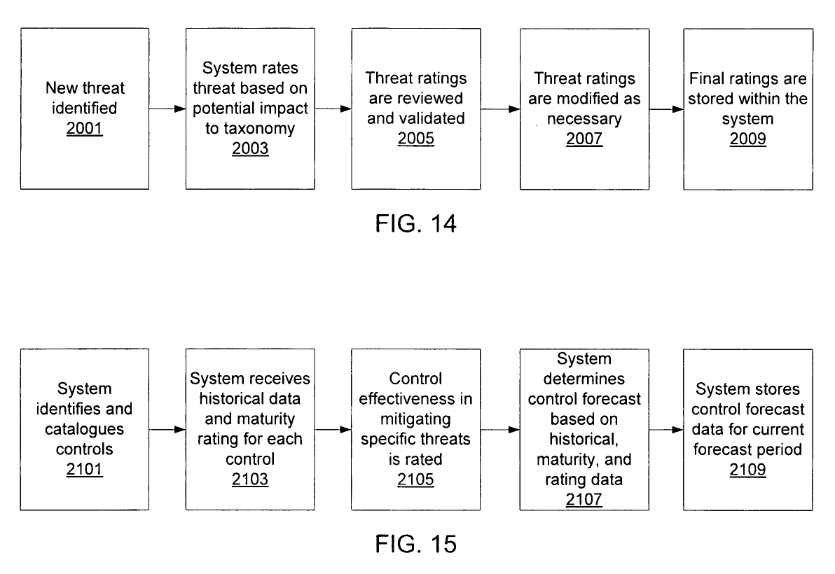

FIG. 12 is an example flowchart illustrating a process for forecasting risk associated with a project in accordance with at least one aspect of the present invention. The process starts and in step 1801, the system receives business project data from the business driver library, such as business driver library 1601 in FIG. 10. The business project data from the business driver library may be the project forecast and ratings data described with respect to FIG. 13 below. In step 1803, the system identifies threats relevant to the project based upon a taxonomy. Such a taxonomy may be a standardized taxonomy, such as the information security and business continuity (ISBC) taxonomy. As should be understood by those skilled in the art, the ISBC taxonomy is but one type of taxonomy and other taxonomies may be utilized in its place. As described herein, the illustrative figures utilize the ISBC taxonomy but the present invention is not so limited. The identification of threats is further described below with respect to FIG. 14.

Proceeding to step 1805, the system identifies relevant controls for the identified threats. The identification of relevant controls is further described below with respect to FIG. 15. In step 1807, the system determines the residual risk and forecast scores for the project. Then, in step 1809, the system may store and/or disseminate a report of the total residual risk for the project/initiative. Such a report may be utilized to further address risk associated with a project.

FIG. 13 is an example flowchart illustrating a process for addressing business initiatives in accordance with at least one aspect of the present invention. The process starts and in step 1901, the relevant line of business projects are identified as needing to be addressed. In step 1903, certain project requirements are mapped to the ISBC taxonomy. As previously indicated, it should be understood that the ISBC taxonomy is merely illustrative and other taxonomies may be utilized in accordance with one or more aspects of the present invention.

Moving to step 1905, the project requirements are rated based on the importance of the requirement to the overall project. At step 1907, the system performs project forecast determinations for how the project and its requirements will evolve over a specific period, such as an eighteen month period. In step 1909, the system may store the project forecast and ratings data in a storage device, such as in business driver library 1601 in FIG. 10.

FIG. 14 is an example flowchart illustrating a process for rating threats in accordance with at least one aspect of the present invention. The process starts and at step 2001, new threats are identified. As described above, in these examples, the identified threats are ISBC threats. In step 2003, the system assigns rates each threat based on the potential impact to the ISBC taxonomy.

Proceeding to step 2005, the assigned threat ratings may reviewed and validated per respective threat. In step 2007, the threat ratings may be modified as necessary in response to the review and validation in step 2005. Then, in step 2009, the final ratings are stored within the system, such as in threats library 1603 in FIG. 10.

FIG. 15 is an example flowchart illustrating a process for maintaining a control library in accordance with at least one aspect of the present invention. The process starts and at step 2101, the system identifies and catalogues controls with respect to the initiative/project. In step 2103, the system receives historical data and a maturity rating for each control. Proceeding to step 2105, the effectiveness of a control in mitigating specific threats is rated by the system. Based on the historical, maturity, and rating data, the system determines a forecast of the control in step 2107. Such a forecast is a determination of how the control will evolve over a specific period, such as an eighteen month period. Then, in step 2109, the system stores the control forecast data for a current forecast period. The system may store such information in a library, such as control library 1605 in FIG. 10.

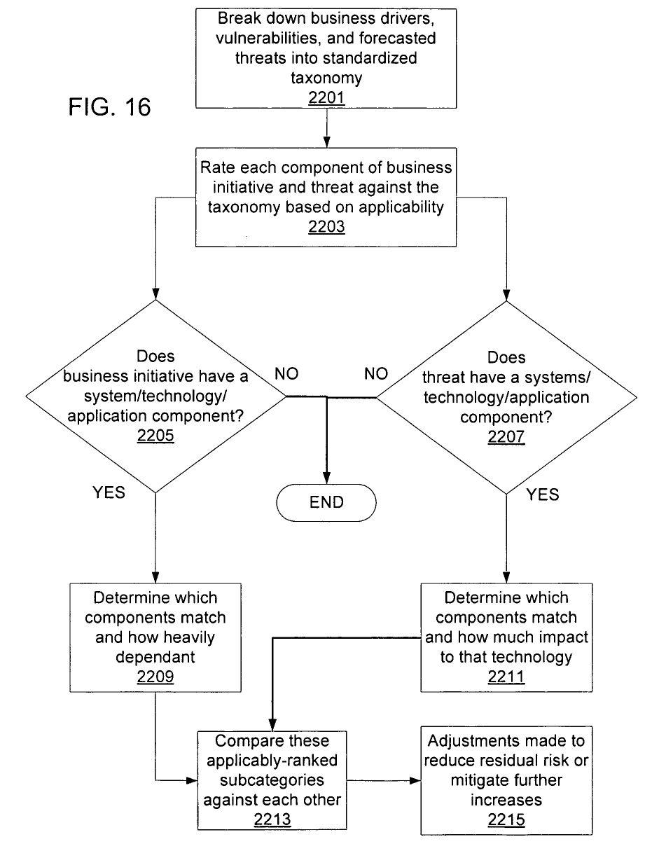

FIG. 16 is an example flowchart illustrating a process for determining a relationship between a business driver and a forecasted threat in accordance with at least one aspect of the present invention. As previously described with respect to FIGS. 12-15, step 2201 provides for the break down of business drivers, vulnerabilities, and forecasted threats into a standardized taxonomy, such as ISBC taxonomy. A component tree may be generated with respect to each and every component of the business initiative/project.

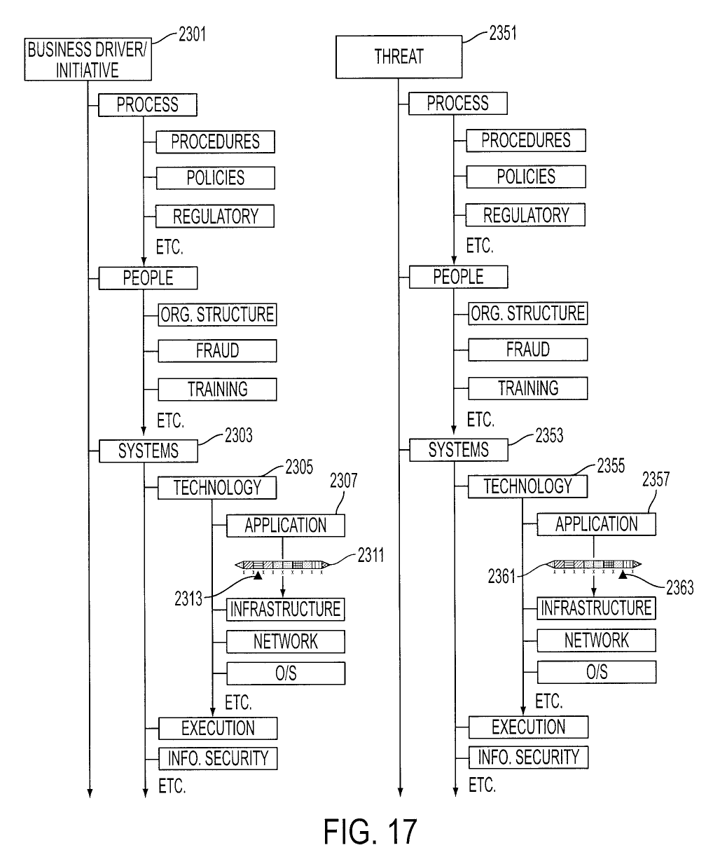

FIG. 17 is a block diagram of an illustrative tree identifying various components of a business driver/initiative and a forecasted threat in accordance with at least one aspect of the present invention. In FIG. 17, reference element 2301 identifies the business drivers/initiatives. In the example shown in FIG. 14, business driver 2301 includes a Systems component 2303. Included within Systems component 2303 is a Technology component 2305, and within Technology component 2305 is an Application component 2307.

Also included within FIG. 17 is a break down of the forecasted threats 2351 into a standardized taxonomy. In the example shown in FIG. 14, threat 2351 includes a corresponding Systems component 2353. Included within Systems component 2353 is a Technology component 2355, and within Technology component 2355 is an Application component 2357.

With the business drivers, vulnerabilities, and forecasted threats broken down into a standardized taxonomy in step 2201, the process moves to step 2203 where each component of the business driver/initiative and threat against the taxonomy is rated based on the applicability of the component. With respect to the example shown in FIG. 17, the Application component 2307 is shown to include a rating 2313 on a scale 2311. In such an example, the rating may indicate how dependent the overall project is to that Application component 2307. In this example, the rating 2313 is shown as to the far left on the scale 2311, which may indicate a rating that is very low to indicate that the overall project does not heavily depend on Application component 2307.

Also shown is that corresponding Application component 2357 for threat 2351 includes a rating 2363 on a scale 2361. In such an example, the rating may indicate how much of an impact that threat would have on such an Application component 2357. In this example, the rating 2363 is shown as to the far right on the scale 2361, which may indicate a rating that is very high to indicate that the threat does have a high impact on an Application component 2357.

Returning to FIG. 17 and proceeding to step 2205, a determination is made as to whether the business driver/initiative 2301 has a Systems/Technology/Application component 2307 to match a corresponding Application component 2357 in the threat 2351. Concurrently, a determination is made in step 2207 as to whether the threat 2351 has a Systems/Technology/Application component 2357 to match corresponding Application component 2307. If the answer to both steps 2205 and 2207 is yes, the process moves to steps 2209 and 2211, respectively.

In step 2209, the system determines which of all the components of the business driver/initiative 2301 match and how heavily dependant the overall project is on the matching components, such as Application component 2307. In step 2211, the system determines which of all the components of the threat 2351 match and how much of an impact the threat will have on the matching components, such as Application component 2357. The information from steps 2209 and 2211 are forwarded to step 2213 where the applicably-ranked matching subcategories are compared against each other. In step 2215, adjustments may be made based upon the compared ratings to reduce the overall residual risk associated with a project and/or to mitigate further increases in residual risk over time.

One or more aspects of the present invention for forecasting risk associated with a project may include an algorithm for calculating risk from a threat. Table 1 below is an illustrative table for a scoring system used with an algorithm for calculating a threat metric score associated with a particular threat. As should be understood by those skilled in the art, the below Table 1 is but one illustrative table and that other formats may be utilized to model threats and their impact on an entity.

TABLE 1

| Score | 1. Maturity | | 2. Adoption | | 3. Impact |
|---|---|---|---|---|---|
| 10 | <1 | year | >100% | increase in the last 180 day cycle | High |
| 8 | <18 | months | >80% | increase in the last 180 day cycle | Moderately High |
| 5 | <2 | years | >50% | increase in last 180 day cycle | Moderate |
| 3 | <4 | years | 30% | increase in the last 180 day cycle | Moderately Low |
| 1 | >5 | years | <10% | increase in last 180 day cycle | Low |

In the example in Table 1, an algorithm may be utilized to calculate a threat metric score. For an example of malware, in determining the forecasted impact of a 25% increase in a new vector of viruses over the last 180-day cycle and utilizing the scoring system from Table 1, a threat metric score may be determined by:

Threat Metric Score=[2^{M1(s)}+2^{M2(s)}+2^{A(s)}+2^{I(s)}]/16,

where M1 represents a current maturity rating for a control on the threat, M2 represents a forecasted maturity rating for the control on the threat, A represents the historical adoption of the threat over the last 180-day cycle, and I represents the forecasted impact of the threat. In the illustrative example above, the threat metric score or forecasted score would be 12.5. Such an indication may be correlated against a secondary table to identify the significance of the impact. For example, a score from 0-17 may indicate the impact on the overall project to be significantly decreased. A score from 18-49 may indicate the impact to be moderately decreased. A score from 50-113 may indicate the impact to be stable/no change. A score from 114-193 may indicate the impact to be moderately increased, and a score from 194-256 may indicate the impact to be significantly increased.

This scoring system as described herein may be utilized as part of the determination made with respect to step 2107 in FIG. 15. As should be understood by those skilled in the art, the above is but one example scoring metric system and other calculations may be utilized to determine a forecasted score.

The Threat Modeling and Risk Forecasting module in and of itself creates a sustainable mechanism for managing risk. For example, it can generate a record that describes the process through which the risk was assessed which is useful for auditing, monitoring, tracking etc. purposes. Further, the Threat Modeling and Risk Forecasting module creates an overall quantifiable output, namely quantified risks, or scores, which can be used in conjunction with compliance processes. For example, the scores (along with all other related data) may be contained in the Threat Modeling Risk Forecasting module 404. Therefore, such information will be available throughout the entire system 400. According to one aspect of the invention, in order for a project to be approved, a score may have to be in an acceptable range. If a project is approved when a score is not in an acceptable range, the compliance monitor may be alerted through the integrated system 400 and appropriate action can be taken.

The Threat Modeling and Risk Forecasting module's standardized method of quantifying risk can ensure compliance processes are followed. Alternatively, or in addition to, other aspects of the Threat Modeling and Risk Forecasting module can be used with the compliance process. For example, if a step of the method, (e.g., step 1130 appropriate solutions to close gaps as selected [see FIG. 8]) is not completed, a compliance monitor may be alerted and appropriate action taken.

Vendor Management Module

According to a particular embodiment of this invention, the system can include a module directed to a third party supplier (i.e. vendor) risk assessment and management system that will determine and manage the risk associated with an organization's potential business relationship with a third party vendor or supplier. It is noted, that a business relationship may be any type of relationship wherein the vendor or supplier provides a service or product to the organization. For example, such business relationships may include supplying hardware, developing software, providing health benefits to an organization's employees, providing information security to an organization's technological infrastructure, etc.

Particular aspects of this Vendor Management System are directed to the process for determining risk. This process may be embodied as an automated process that is implemented on a computer system such as described earlier in the application. Therefore, this third party vendor risk management module has the ability to reduce or eliminate manual effort. In such an automated embodiment, the vendor management system may contain several modules including a Supplier Profile module, a Supplier Business Relationship module, an Assessment Summary module, an Assessments module, a Findings module and a Questions Bank module. Using one or more of these modules, a risk can be a determined and/or managed by the organization. Further, as will be described below, the Vendor Management module can transfer the risk to the respective LOB by informing the LOB of the analyzed risk and then the LOB can make the decision whether to engage in or continue business with the third party vendor. Further, the Vendor Management module can increase security and storage of historical data and also do historical analysis of the third party vendor its relationships.

Not only does the Vendor Management System benefit the organization by providing it with a quantified risk to determine whether the organization should engage in, or continue with, a business relationship with a third party vendor, but such risk management may be mandated by the federal government. For example, as discussed above, in the United States, the OCC oversees the banking industry. The OCC expects the board of directors of a banking institution to properly oversee and manage all of the banking institution's business relationships with third parties. The OCC also expects the banking institutions to adopt a risk management process that includes: a risk assessment to identify the banks needs and requirements; proper due diligence to identify and select a third party supplier; and ongoing oversight of the third parties and third party activities. The OCC has the authority to inspect whether a banking institution has such a risk management process in practice. The Vendor Management System and process fulfill this risk management requirement. Therefore, while the Vendor Management System and process described below would be beneficial to any organization, the process and system may be especially applicable to the banking industry.

Risk Assessment Process

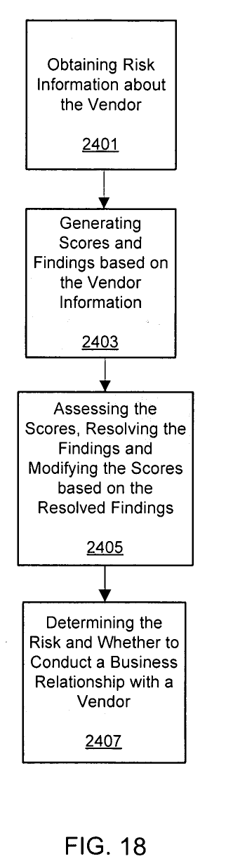

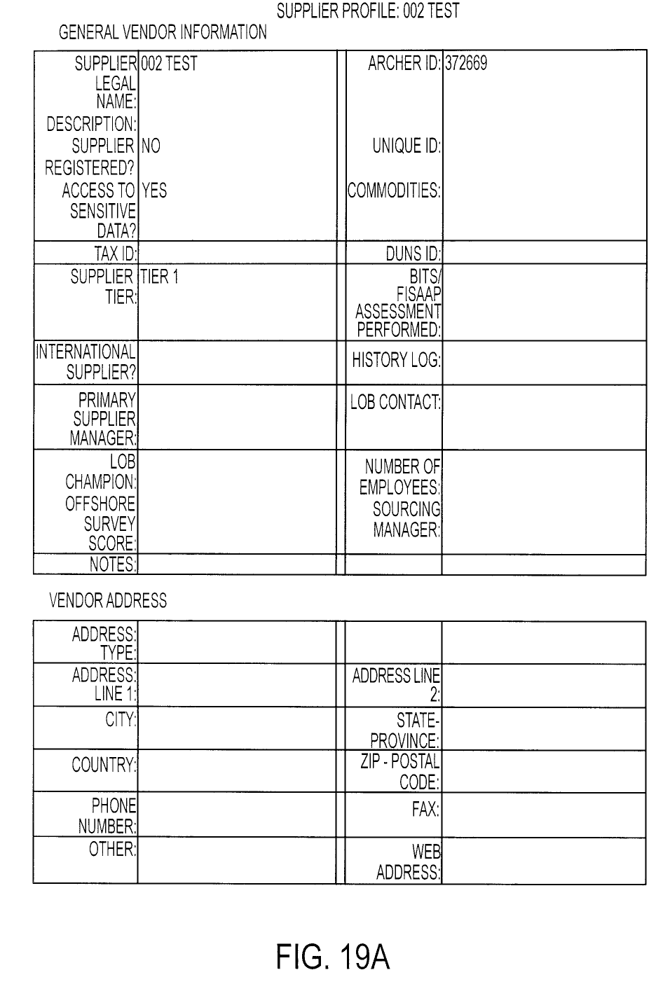

A risk assessment process according to at least one aspect of this invention is described below with reference to FIG. 18. As shown in an illustrative flowchart of this process seen at FIG. 18, the steps include: obtaining risk information about the inventor 2401, generating scores and findings based on the vendor information obtained 2403; assessing the scores, resolving the findings and modifying the scores based on the resolved findings 2405; and determining the risk and whether to conduct a business relationship. Each of these steps is described in detail below.

Obtaining Risk Information About the Vendor

According to one aspect of this disclose, a risk assessment process includes obtaining risk information about a vendor wherein the risk information relates to the particular business relationship the vendor would have with the organization. The information may be the obtained either by the vendor submitting answers to questions about the risk information or, alternatively, such information may be gathered by the organization itself.

For example, in order to establish a business relationship with an organization, the organization may require that the vendor answer a series of questions relating to the particular business relationship. According to particular aspects of this invention, a vendor may be directed to log into a system, such as a website, located at a particular URL in order to access the series of questions. The vendor may then submit answers to these questions through this online environment. Purely by way of example, if the business relationship were to involve the vendor handling the organization sensitive data, then the questions may relate to the vendor's ability to protect the sensitive data which the organization has provided. As protecting the organization's sensitive data relates to several different aspects of a vendor's operation, the questions may be grouped according to those different aspects or categories. For example, categories of questions related to protection of sensitive data may include: access control, asset management, business continuity, communications and operations, compliance, incident management, insider threat, information systems acquisition, development and maintenance, physical and environment security, security policy. Accordingly, each of these categories may have their own plurality of questions.

Generating Scores and Findings Based on the Vendor Information Obtained

In order to receive a score for a category, the vendor would have to answer the questions related to that category. For example, a question in the access control category may be: “What are the password standards in place in your [the vendor's] technological infrastructure?” In answering the question the vendor can choose from a series of appropriate responses. For example, the series of answers to this question may include choices of if the vendor's password standards currently in place require:
a password of a minimum 8 characters in length,
a password with at least one alpha character and one numeric character,
the passwords must be changed every 90 days,
the system preventing reuse of a previous password.

According to an aspect of this invention, a score is generated for this question based on the number of choices the vendor included in their answer. For example, if the vendor's answer indicated that the vendor's password standards include three out of four features, then a particular score would be associated with this answer. While the score associated with this answer may be produced according to one or more algorithms or other procedures into which the vendor's answer is inserted, for explanation purposes, a simplified example score of 75% is used here.

There may be several other questions in this category of access control that the vendor must answer. For example, further questions may relate to the vendor's system's lock-out procedures, authentication procedures, user account controls, etc. All of these questions may be answered in a similar manner of choosing all the appropriate choices which apply and, therefore, a corresponding score may be produced for each of these questions. Once all the answers for a particular category are submitted, an overall score for the category is generated. For example, an overall score for the individual category of a vendor's access control is generated based on the vendor's answers.

Similarly to the above example describing the category of access control, the vendor would have to answer a plurality of questions in other categories. Therefore, the vendor would receive scores for each of the questions too. In the example given above of a business relationship involving the vendor handling the organization's sensitive data, in addition to access control, the categories may include: asset management, business continuity, communications and operations, compliance, incident management, insider threat, information systems acquisition, development and maintenance, physical and environment security, security policy, etc. The vendor would receive individual overall scores for each of these categories that are generated in the manner described above.

According to another aspect of this invention, once the vendor's answers to the questions are evaluated, the Vendor Management process may generate a “finding” with respect to each question. A “finding” may be considered to be a gap or difference between the organization's “correct” (i.e. “preferred”) answer and the vendor's actual answer. The findings serve as indicator to the organization that a vendor may pose a potential risk to the organization.

For example, in the above question regarding a vendor's password standards, the vendor's answer indicated that the password standards included three of the four of the features (i.e. (1) a minimum 8 characters in length, (2) at least one alpha character and at least one numeric character, (3) the passwords must be changed every 90 days). However, the vendor's standards fail to include the fourth feature of a system preventing reuse of a previous password. The organization may have set the “correct” answer to be that all four of the standards must be met by the vendor. Therefore, along with the score of 75% that is generated, a finding is generated noting that the vendor's system does not have this fourth feature.

Assessing the Scores, Resolving the Findings and Modifying the Scores Based on the Resolved Findings

According to another aspect of this invention, the process allows the organization to resolve the findings and, thereby, provides the opportunity for a particular score to be modified. Under this process, once an answer to a question is considered “incorrect” and a finding is be generated (i.e. “opened”), a member of the organization who responsible for reviewing and authorizing a business relationship with a vendor may contact the vendor to resolve the finding. For example, a particular finding might be applicable to a vendor. For example, a vendor who does not allow work to be done outside a secure facility would not have a need for a secure Virtual Project Network (VPN). In that case the organization may close (i.e. waive) the finding. Alternatively, the organization could close the finding after discussion with the vendor about the finding, wherein the vendor agrees to implement the lacking feature by a certain date. Upon closing the finding, the vendor's score would increase. In the above example of the score of 75% based on the three out of four password features in the vendor's system, if the organization reviewed the finding, contacted the vendor and the vendor implemented this fourth feature, then the organization may close the finding and the vendor would receive a score of 100% indicating that the vendor would no longer be considered a potential risk.

Determining the Risk and Whether to Conduct a Business Relationship with a Vendor

This Vendor Management process provides the ability to modify the vendor's scores based on resolution of findings and thereby it can ensure that the compliance procedures are being followed. In other words, if, for example, the organization has a compliance procedure that no business relationship may be approved unless there are no findings or, alternatively, all findings are closed, then a member of the organization would be responsible for ensuring that the open findings are closed. Hence, the organization would be reducing the potential risk associated with a business relationship. If on the other hand, the findings were not resolved, then the organization could determine that there is still a potential risk, and accordingly the organization could decide not to conduct a business relationship with the particular vendor.

Online vs. Onsite Assessments

At least one aspect of this invention is directed to an online assessment wherein the vendor will submit answers to questions into a computer system as described above. This online assessment reduces the manual effort (and also time and expense) required of an organization, since the online assessment is self sufficient in that the vendor can access the system (e.g. a website) and provide the information at the vendor's convenience without the organization's input. This system can also compute the associated scores and findings based on the vendor's answers without manual intervention of the organization. Therefore, only during the assessing of the scores and resolution of the findings will the organization's resources become involved.

As mentioned above, another way to obtain information about the vendor is for the organization, itself, to gather the information. One method of gathering such information is an onsite assessment. In an onsite assessment the organization may evaluate the vendor by gathering data about the vendor supplier through any means other than the online assessment. For example, in an onsite assessment, a member of the organization may travel to the vendor's location to confirm (or obtain additional details about) the answers the vendor provided in an online assessment. The onsite assessment may provide differing scores from the online assessment.

The Modules

As mentioned above, the process may be implemented in a computer system. In such an embodiment, the Vendor Management System may contain several modules including a Supplier Profile module, a Supplier Business Relationship module, an Assessment Summary module, an Assessments module, a Findings module and a Questions Bank module. These modules will be described below.

Supplier Profile Module

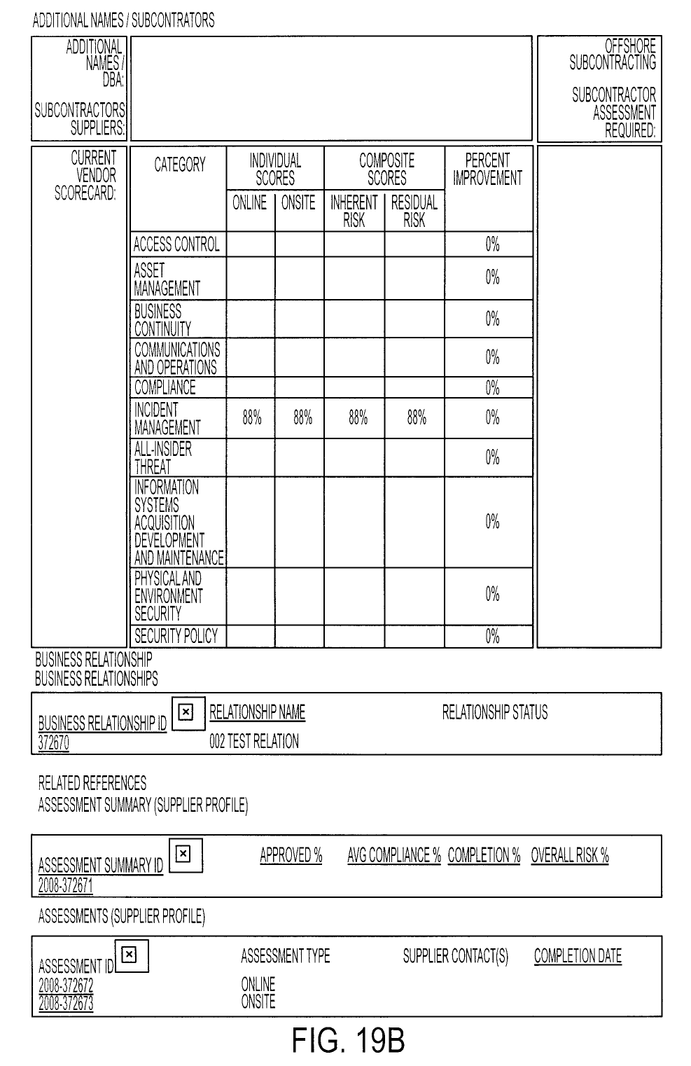

The supplier profile module will record and store basic profile information and data pertaining to business relationships between the organization and past, current or potential third party vendors. FIGS. 19A-B disclose an illustrative embodiment of a supplier profile. As shown in FIGS. 19A-B, a supplier profile may contain fields for information such as the supplier's name, location/address, number of employees, an identification number, whether the supplier has access to sensitive data, if they supplier is international, the LOB within the organization to which the supplier, subcontracts with which the supplier operates, etc. The profile may also contain a copy of a vendor scorecard. A vendor scorecard provides an overview of the organization's risk in conducting a business relationship with the vendor. The scorecard may be directed to several different risk areas for a particular business relationship. For example, the scorecard in FIG. 19B illustrates the above discussed example of a business relationship with a third party vendor with risk areas associated with protecting the organization's sensitive data provided to the third party vendor. As seen in the scorecard, such risk areas may include the third party vendor's: access control, asset management, business continuity, communications and operations, compliance, incident management, insider threat, information systems acquisition, development and maintenance, physical and environment security, security policy, etc. As mentioned above, the embodiment of the scorecard is merely illustrative and other categories could be included or listed categories shown in FIG. 19B could be removed depending on the particular situation to which the scorecard is directed. The scorecard may include individual overall scores generated from the above described process. Additionally, the scorecard may include a section for showing the improvement of a particular supplier in each of these categories that may be updated depending on changes to the vendor's status. For example, once the supplier answers the assessment, findings may be generated. The next step involves the supplier and the organization's assessor remediating the findings. During remediation, if the supplier agrees to change his standards to conform to the organizations requirements and provides sufficient documentation to that effect, the assessor may decide that the finding can be resolved and accordingly the residual risk score changes as reflected in the column in the scorecard. The goal is to reach 100 for each category if the residual risk is not already 100.

The supplier profile may also contain a section directed to a business relationship the organization has with the supplier. As seen in FIG. 19B, this section may include fields for the business relationship identification number (which may correspond to a document), the relationship name and status. Further, this section may contain links to another module directed specifically to storing information regarding the business relationship. For example, the displayed business relationship ID may be a hyperlink to that document contained in the Supplier Business Relationship Module. Therefore, a user can use that link in the Supplier Profile to access additional information regarding the business relationship.

Typically, an organization may have more than one business relationship with a particular vendor. For example, a particular vendor may a first business relationship for developing computer software for the organization. In addition to that relationship, the same vendor may have a second business relationship wherein it develops hardware for the organization. Each relationship may have its own risk associated with it. Therefore, one aspect of this invention is directed to determining a risk regarding each of these relationships, rather than merely an overall risk for vendor. This is not to suggest that an overall risk for a particular inventor can'be determined by the Vendor Management System, but instead the Vendor Management System can provide more accurate information by including a risk for each relationship. Therefore, the organization can determine whether a first relationship with a particular vendor may be acceptable, while a second business relationship might not. Based on such a determination, a different vendor can be chosen for the second particular business relationship. Further, if the one relationship performs poorly in an assessment, the risk can be transferred to the particular LOB which then makes a decision about engaging the vendor's service. The LOB may or may not terminate the contract on all services provided to the organization by the vendor. Sometimes, the risk in one assessment is deemed great and may spill over to other services and at that time, they may decide to terminate the contract. In some cases they may decide to absorb the risk and continue the engagement. Hence, as seen in FIG. 19B, the Supplier Profile may list and contain links to each of the particular business relationships the organization has with a single vendor.

The Supplier Profile may also contain a section directed to the assessment summary of the supplier. As seen in FIG. 19B, this section of the supplier profile may include the assessment summary identification number (which may correspond to a document), the approval percentage, the average compliance percentage, the completion percentage and overall risk. Further, this section may contain links to another module directed specifically to storing the assessment summary information of the supplier. For example, the assessment summary ID may be a hyperlink to that document contained in the Assessment Summary module. Therefore, a user can use this section of the Supplier Profile to access additional information regarding the vendor's assessment summary.

The Supplier Profile may also contain a section directed to the actual assessments of the supplier or vendor. As seen in FIG. 19B, this section may include the assessment identification number (which may correspond to a document), the type of assessment, supplier contract, and the completion date. Further, this section may contain links to another module directed specifically to storing the assessments. For example, the assessment ID may be a hyperlink to that document contained in the Assessment module. Therefore, a user can use this section of the Supplier Profile to access additional information regarding the individual assessment.

Overall, the Supplier Profile provides an overview of the organization's business relationship with a third party vendor and risk associated with it. The Supplier Profile also provides links to other modules in the system, so the user can quickly access further detailed information regarding that business relationship and how the risk was determined. The specific modules and information that are used in making up the Supplier Profile are discussed below.

Supplier Business Relationship Module

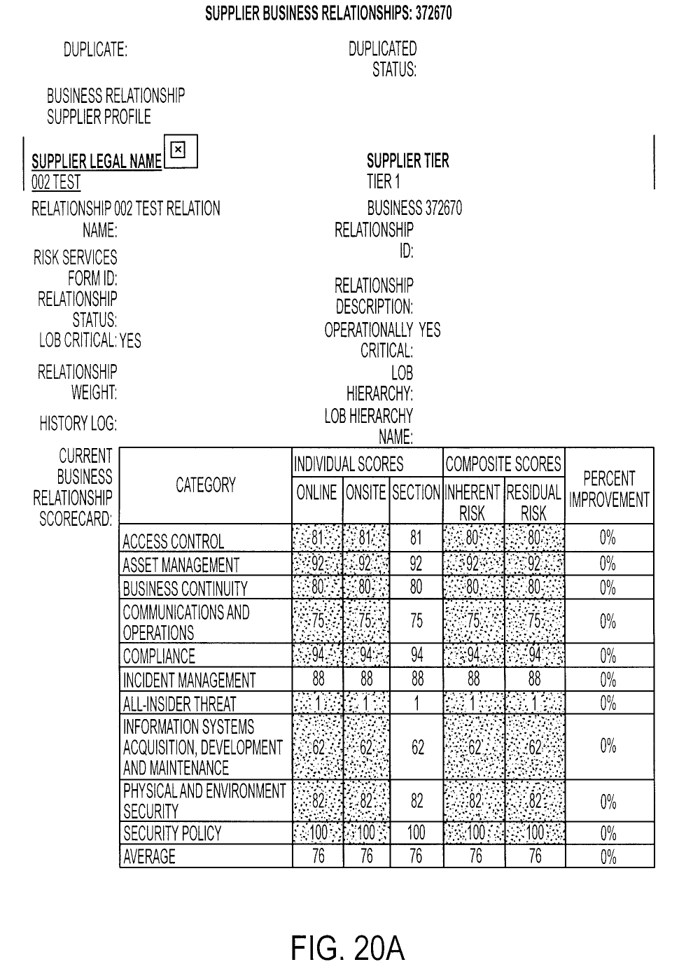

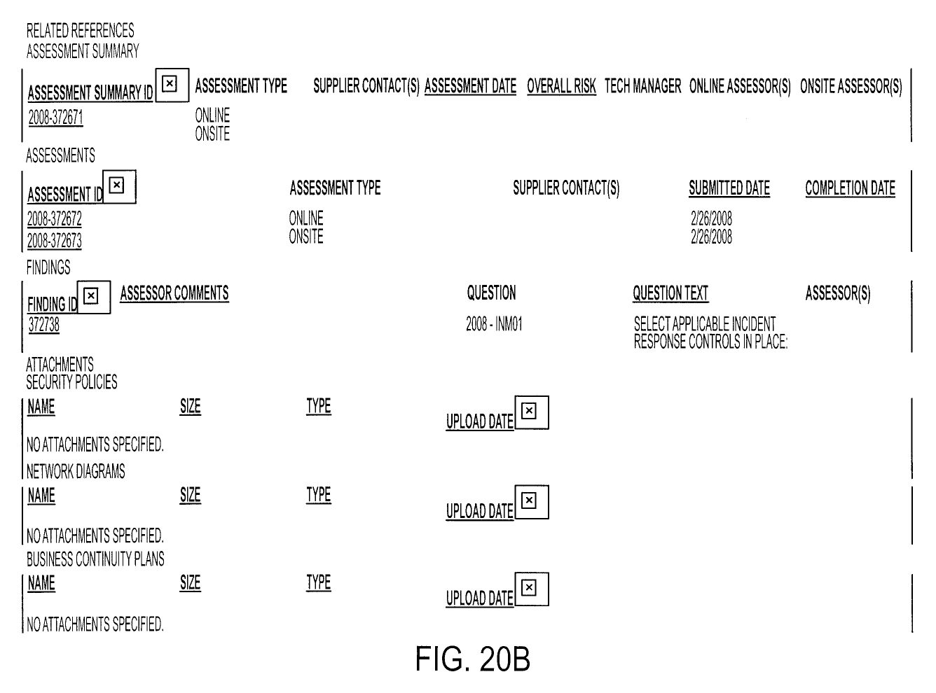

The Supplier Business Relationship Module will record and store business relationship data between the organization and past, current or potential third party vendors. For example, FIGS. 20A-B show an illustrative embodiment for a format of a Business Relationship Summary that is contained in the Supplier Business Relationship Module. As discussed above, an organization may have multiple business relationships with a particular vendor. Each of these business relationships would have its own Supplier Business Relationship Summary. Although it is noted that each Summary may reference or link to another Business Relationship Summary for a particular vendor.

As seen in FIG. 20A, the Business Relationship Summary may contain a section directed to the Supplier Profile, which includes general information such as vendor name, LOB with which the vendor works, etc. Further, the Business Relationship Summary may include a copy of the vendor's current scorecard for that particular business relationship. The Business Relationship Summary may also include a related reference section which has information about and links to the Assessment Summary, the actual Assessments, Findings (open or closed), etc.

Additionally, a particular format for a Business Relationship Summary contained in this module may also include attachments. As shown in FIG. 20B, examples of the attachments may include security policies, network diagrams, business continuity plans, etc.

Assessment Summary Module

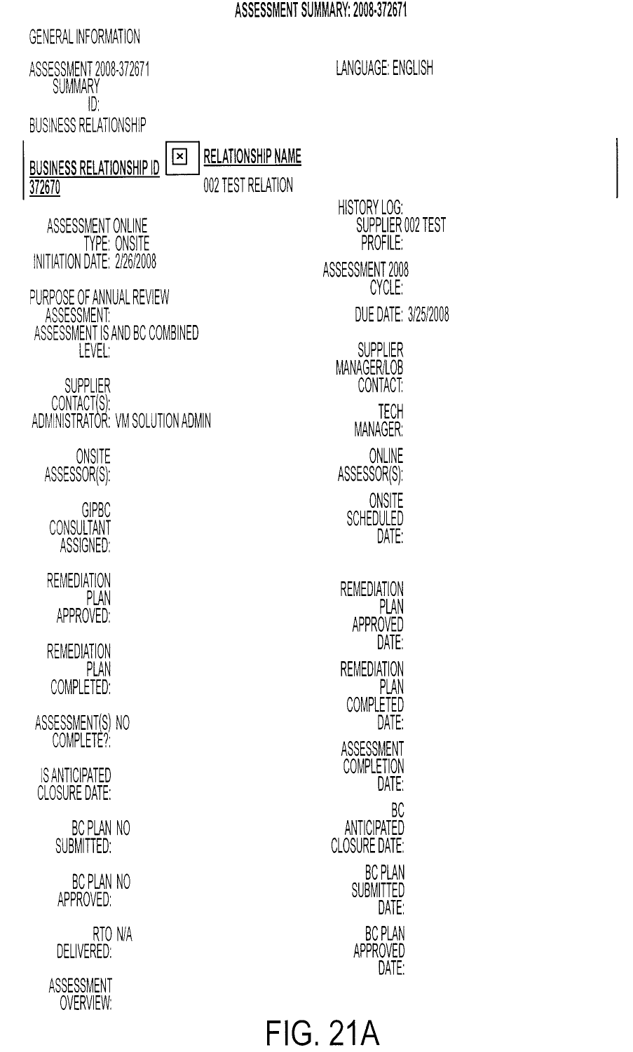

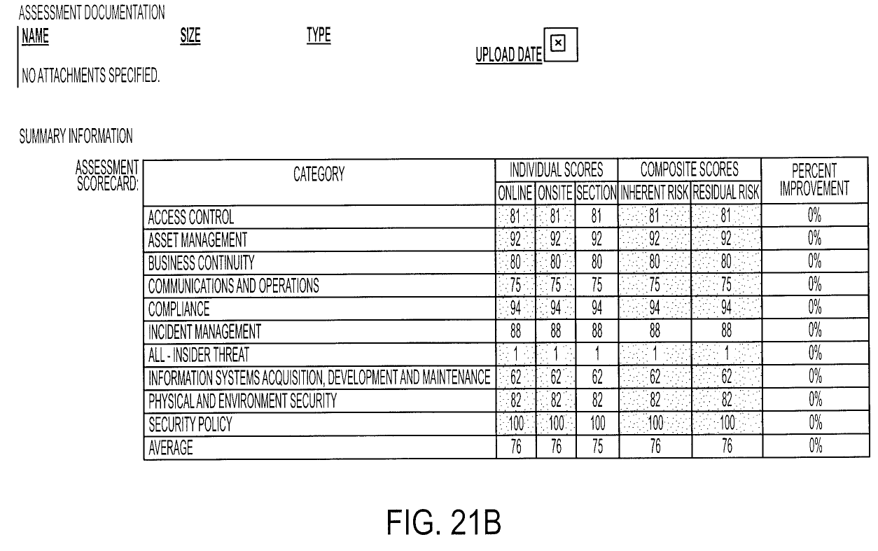

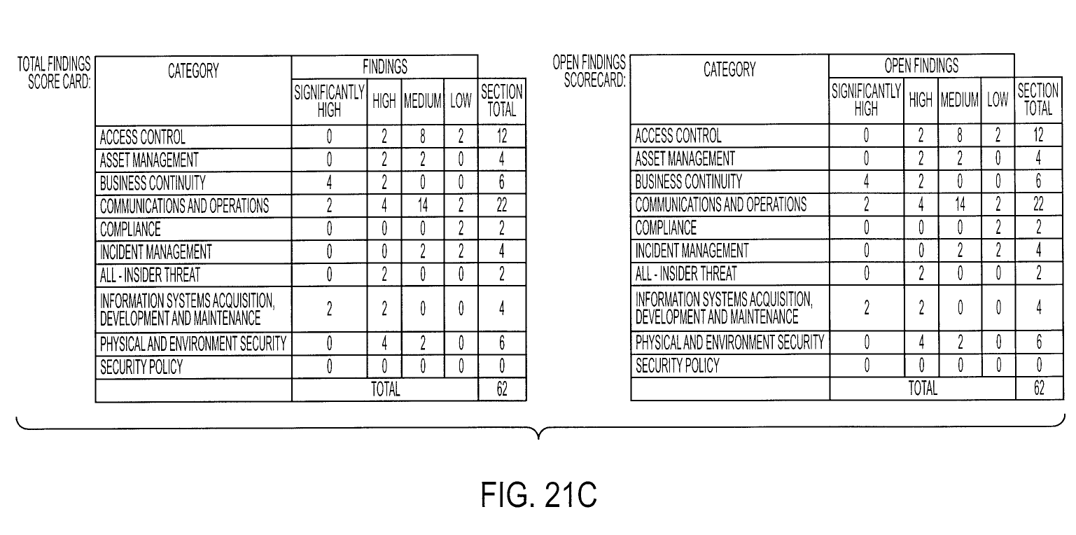

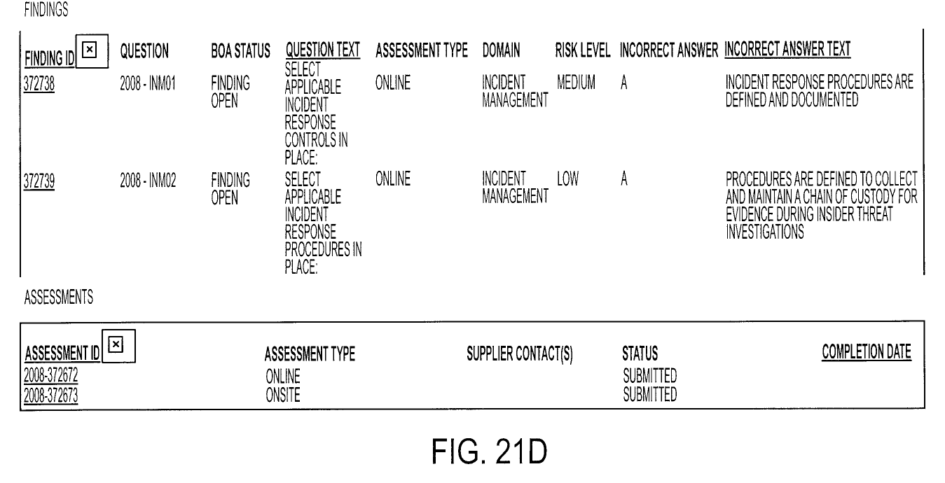

The Assessment Summary Module will record and store summarized information from the actual assessments of third party vendor and the business relationship between the organization and that third party vendor. In other words, these assessment summaries condense and summarize all the vendor information that was obtained through the actual assessments conducted by the organization (e.g. the assessment summary would contain information from both an online and an onsite assessment). FIGS. 21A-D shows an illustrative embodiment of such an Assessment Summary that could be stored within the Assessment Summary Module. As seen in FIG. 21A, the Assessment Summary may contain a section directed to general information, which includes information such as the assessment summary ID, etc. Further, the Assessment Summary may contain a section directed to a business relationship the organization has with the supplier. As seen in FIG. 21A, this business relationship section may include fields for the type of assessments through which vendor information was obtained (e.g. online or onsite). Further, this section may also contain information about the assessments, such as the purpose of the assessment, dates pertaining to when the assessment was initiated and completed, who conducted the assessment, if a remediation plan was involved (e.g. if a finding was generated during the assessment, a remediation plan may be a plan for the vendor to correct the issue and thereby close the finding), the status of that remediation plan, etc. Additionally, as seen in FIG. 21B, the assessment summary may contain a vendor scorecard, such as described above. Further, as seen in FIG. 21C, the assessment summary may contain other scorecards such as an open findings scorecard and a total findings scorecard. The Total Findings scorecard may reflect the total number of findings generated when the assessment is submitted. Initially, the total findings and the open findings scorecard show the same number. As the vendor continues to remediate the findings with the organization, the findings are closed, and this reflects the number of Open findings. The goal is to remediate all the findings and the count should reach 0 in the Open findings scorecard. Additionally, the organization can assign each answer on a question with a risk rating of Significantly High, High, Medium and Low. As the findings are generated for the answers, the risk rating on the answers is transferred to the findings. A significantly High Risk finding is more critical to be remediated than a low risk finding. Still further, as seen in FIG. 21D the Assessment Summary may contain sections directed to the findings or actual assessments. These sections may contain links to the Findings or Assessment modules.

Assessment Module

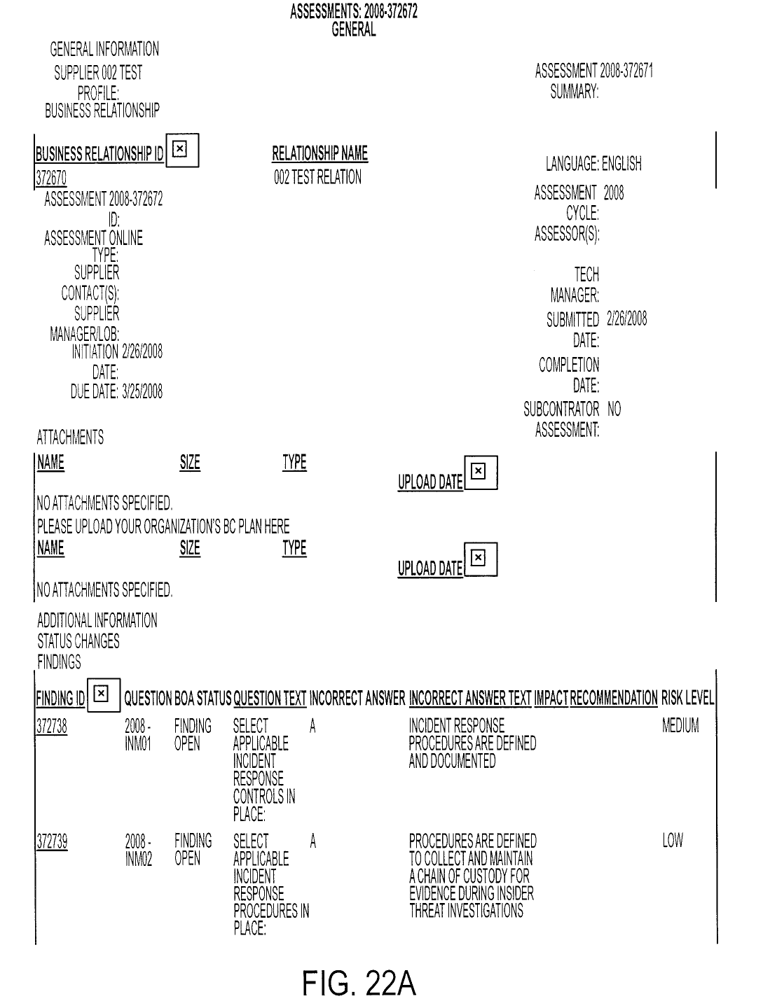

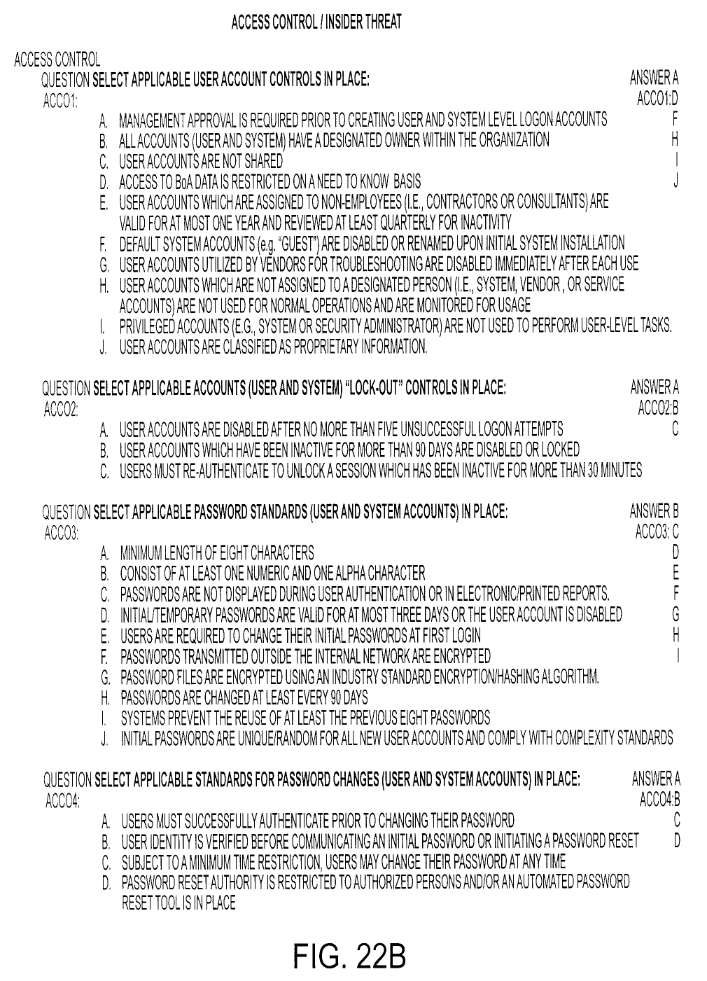

The Assessment module will record and store data related to the actual assessments of the third party vendors. FIGS. 22A-C show an illustrative embodiment of such an Assessment that could be stored within the Assessment Module. Similarly to the other modules, the Assessment may contain sections directed to general information or links to the Supplier Profile, Assessment Summary, Findings, etc. to which the assessment relates. Further, the Assessment may also contain a section directed to a business relationship the organization has with the supplier. As seen in FIG. 22A, this business relationship section may include fields for the Assessment ID, the type of assessments through which vendor information was obtained, supplier contacts, LOB with which the vendor works, etc. The Assessment may also contain additional sections directed to attachments, the vendor's BC plan, etc. wherein the vendor can upload information such as any documentation related to answers or a business continuity plan, etc. Further, the Assessment may also contain an additional sections directed to status changes which may be a audit check to make sure the vendor has not altered the answers once the assessment has been submitted.

As seen in FIGS. 22B-C, the Assessment also contains a listing of the questions that were posed to the vendor during the assessment and, further, the answers the vendor provided to those questions. Therefore, the Assessment allows the reviewer to fully see and understand with the actual responses the vendor gave and where there may be a potential risk to the organization.

Findings Module

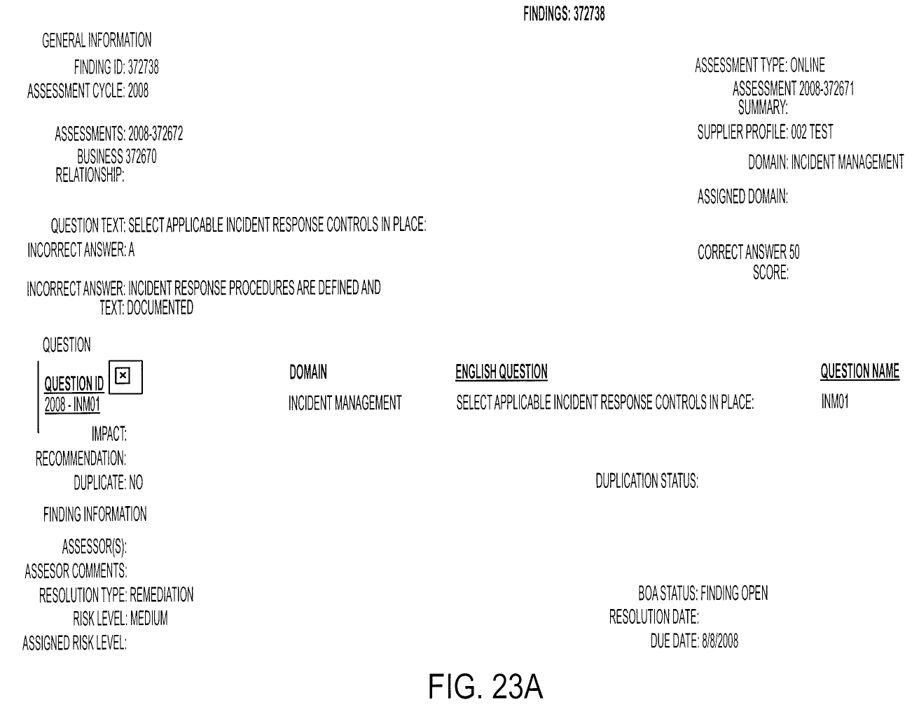

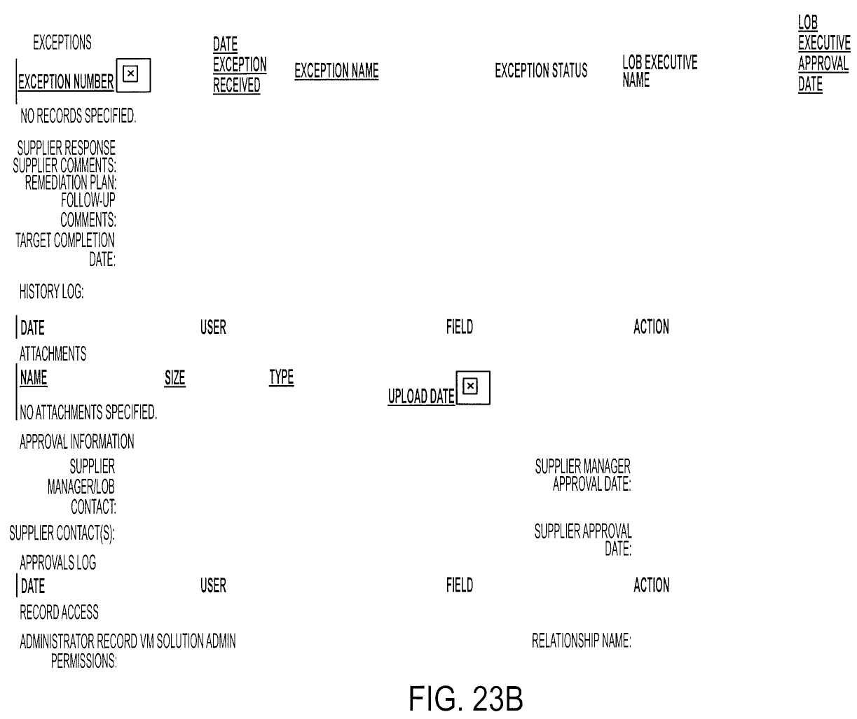

The Findings module will record and store data related to the findings that are generated during the risk assessment process of the vendor. As discussed above, when an “incorrect answer” is given by the vendor during the assessment, a finding is generated, or opened. Summaries of these findings are stored within the Findings Module. FIGS. 23A-B show an illustrative embodiment of such a Finding Summary that could be stored within the Findings Module. Similarly to the other modules, the Findings Summary may contain sections directed to general information, such as the Finding ID, the date of the assessment which generated the finding, the type of assessment, the vendor and their particular business relationship with the organization to which the finding relates, etc. Further, the Finding Summary also contains a section directed to the question from which the finding was generated. Additionally, the Finding Summary also contains a section directed to the actual finding information including who the assessor was, any comments the assessor has, the resolution to the finding, the status of the finding (i.e. if it is open or closed), the risk level to the organization to which the finding relates, etc. Still further, the Finding Summary also contains a section directed to Exceptions. An exception is a result of a finding. For instance, in the above example regarding the vendor's password standards, the vendor's answer indicated that the passwords standards included three of the four features. However, the vendor's standards failed to include the fourth feature of a system preventing reuse of a previous password. The organization may have set the correct answer to be that all four of the standards met by the vendor. If the vendor decides that they cannot accept the fourth condition of preventing reuse of a previous password, they may instead show that they have a better standard in place. In this situation, the organization's assessor has at least two choices. First, the assessor can go onsite to verify their controls. Second, the assessor can raise an exception. Once the exception is raised, the LOB as well as other members of the organization (e.g. an information security officer) may become involved. The LOB may accept the risk for the fourth standard and continue to engage the vendor or the LOB may require the vendor to comply with the standard.

The Finding Summary also contains a section directed to the Supplier (i.e. vendor) Response which may include any comment from the supplier/vendor, the remediation plan and a target completion date, etc. The Finding Summary also contains a section directed to Approval information which includes information about which member of the organization approved the assessment or the business relationship with the vendor and when the approval occurred. This information is useful in determining when compliance processes were followed and if a compliance process was not followed who is responsible.

Question Bank Module

The Question Bank Module will store the questions for the assessments. Further, as described above, the risk assessment process includes predetermined “correct” and incorrect answers to determine the score and findings for a particular question. These predetermined “correct” and incorrect answers are also stored in the Questions Bank Module. Additionally, the Question Bank module also contains the combinations/permutations of choices in a particular answer that will lead to a particular score. For example, in the above described simplified example of a vendor's system having only three out of the four password standards in place, the score was 75%. Such a score would have been based on a rule stored in the Question Bank module that a vendor's answer to the particular question which included the combination of three out of four choices would produce a score of 75%. Again, this is merely a simplified example and such rules and algorithms for determining these scores may be more intricate. For example, the Questions Bank Module would also contain the question's weight as it relates to the potential risk and also how it relates to other questions.

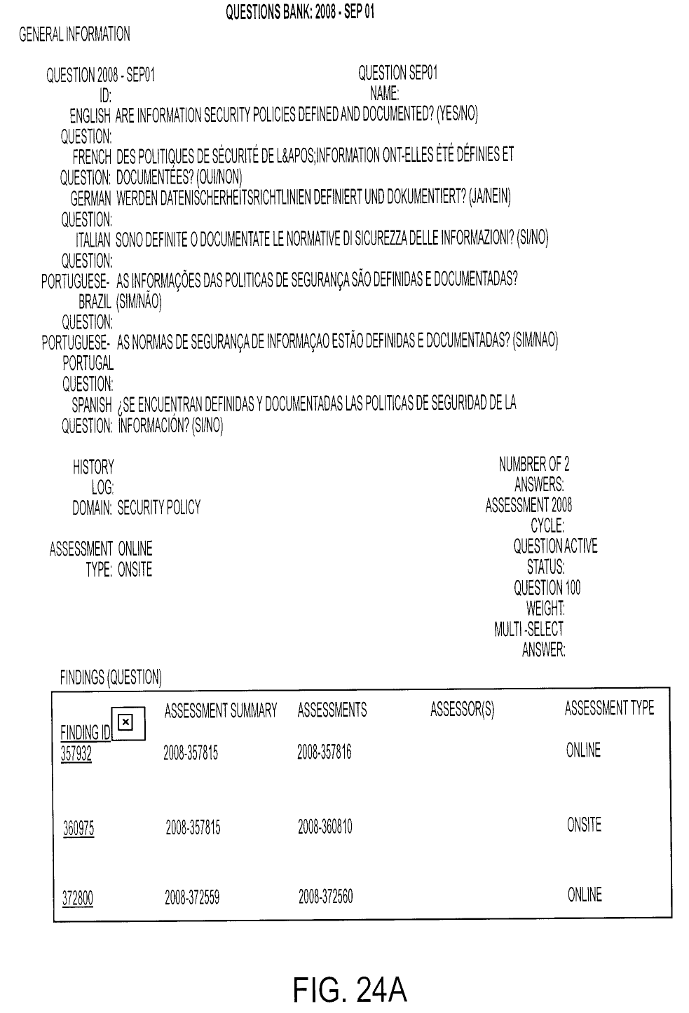

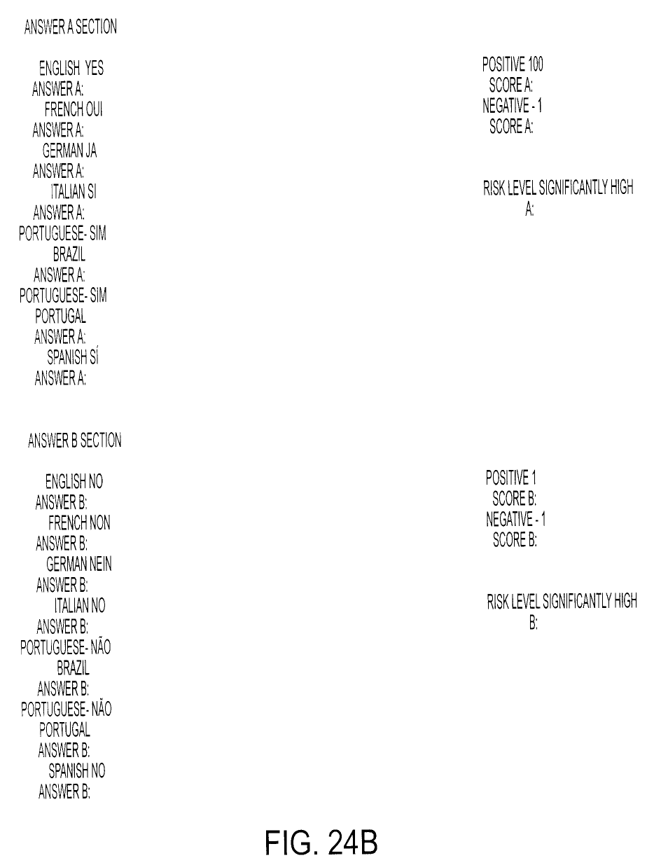

FIGS. 24A-B illustrates an example of a Question Summary that may be stored in the Question Bank module. As seen in FIG. 24A, the Question Summary has a section directed to the question to which the Question Summary relates. It also has a section directed to each of the potential answers to the questions and how each answer will affect the score. For example, as seen in FIG. 24B, there is an Answer “A” section, wherein if the answer is “Yes,” the positive score is 100 and the Negative score is −1. Similarly, there is an Answer “B” section wherein if the answer is “No” the positive score is 1 and the negative score is −1. These sections also include the risk level of the answer. Finally, the Questions Summary also includes a section directed to the findings which may include a link to a particular finding related to the question.

Another aspect of the Vendor Management System is that it can aid in ensuring that compliance processes are followed. For example, as discussed above the organization may have a compliance process in place which requires that a business relationship might not be approved unless an assessment has been done, all the scores are within an acceptable range and any findings generated by the assessment have been closed. This compliance process is to reduce the potential risk to the organization from the business relationship with the third party vendor. Therefore, if a business relationship is approved without the scores being within an acceptable level or findings are open, the Vendor Management system may alert a compliance monitor through the integrated system an appropriate action may be taken. Hence, the integrated system will limit risk to the organization.

Further, the Vendor Management System may also create a record of historical data. This historical data may be useful in many respects. For example, the record may be useful if the OCC needs to inspect to ensure federally mandated risk procedures are being followed. Further, it would be helpful for the organization itself. In the example above where the compliance monitor is alerted, the compliance monitor can quickly determine who approved the business relationship by examining the approval section in the Findings Module.

### CONCLUSION

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present invention. The description is thus to be regarded as illustrative instead of restrictive on the present invention.

1. A method for determining a risk associated with a business relationship with a third party, the method comprising:
identifying a potential third party for conducting a business relationship;
obtaining information about the third party wherein the information comprises answers to a series of questions relating to the risk associated with the business relationship with the third party;
generating at least one score related to the risk associated with the business relationship with the third party;
generating at least one finding about the risk associated with the business relationship with the third party if there is a difference between an answer to one of the series of questions and a preferred answer to that one of the series of questions;
resolving the at least one finding;
modifying the at least one score based on the resolution of the at least one finding; and
determining a risk based on the at least one modified score.

2. The method of claim 1, further comprising:
displaying the series of questions relating to the risk associated with the business relationship with the third party in an online environment;
receiving answers to the questions from a third party through the online environment.

3. The method of claim 1, further comprising:
identifying the third party for a second business relationship;
obtaining information about the second business relationship with the third party;
generating at least a second score related to the risk associated with the second business relationship with the third party;
determining a second risk based on the at least one second score related to the risk associated with the second business relationship with the third party; and
storing and displaying the information and score relating to the second business relationship separately from the information and score relating the third party's first business relationship.

4. The method of claim 1, wherein the step of resolving the at least one finding further comprises:
verifying the answers from the series of questions relating to the risk associated with the business relationship with the third party in regard to the business relationship received an online environment by conducting an onsite assessment;
generating at least one new score related to the risk associated with the business relationship with the third party based on the onsite assessment.

5. The method of claim 1, wherein the step of resolving the at least one finding further comprises:
creating an exception, wherein the exception is a record a potential justification for difference between an answer from a third party to one of the questions in the series of questions and a preferred answer.

6. The method of claim 1, wherein the at least one score generated is a plurality of scores and further wherein each of the plurality of scores is directed to a particular risk category related to the risk associated with the business relationship with the third party.

7. The method of claim 6, further comprising:
displaying the plurality of scores within a scorecard format wherein a first score for a particular category relates to a score generated through an online assessment, a second score for a particular category relates to a score generated through a onsite assessment, a third score for a particular category relates to an inherent risk, a fourth score relates to a residual risk and further wherein the scorecard format displays an improvement of the between original scores and current scores.

8. The method of claim 1, wherein each question of the series of questions relating to the risk associated with the business relationship with the third party is assigned a risk rating, and as findings are generated for particular answers given by the third party, the risk rating is transferred to the finding to indicate the criticality of the particular finding.

9. The method of claim 1, wherein one or more of the questions of the series of questions relating to the risk associated with the business relationship with the third party includes a plurality of choices from which the third party answering the question can choose one, several or all of the choices in its answer, further wherein the score is generated based, at least in part, on difference between the number of choices used in the third party's answer and the number of choices in the preferred answer.

10. A system comprising:
at least one processor;
at least one memory storing one or more computer-executable instructions which, when executed by the processor, perform a method for determining a risk associated with a business relationship third party, wherein the method includes
identifying a potential third party for conducting a business relationship;
obtaining information about the third party wherein the information is answers to a series of questions relating to the risk associated with the business relationship with the third party;
generating at least one score related to the risk associated with the business relationship with the third party;
generating at least one finding about the risk associated with the business relationship with the third party if there is a difference between an answer to one of the series of questions and a preferred answer to that one of the series of questions;
resolving the at least one finding;
modifying the at least one score based on the resolution of the at least one finding; and
determining a risk based on the at least one modified score.

11. The system of claim 12, wherein the method performed by the system further comprises:
displaying the series of questions relating to the risk associated with the business relationship with the third party in an online environment
receiving answers to the questions from a third party through the online environment.

12. The system of claim 12, wherein the method performed by the system further comprises:
identifying the third party for a second business relationship;
obtaining information about the second business relationship with the third party;
generating at least a second score related to the risk associated with the second business relationship with the third party;
determining a second risk based on the at least one second score related to the risk associated with the second business relationship with the third party;
storing and displaying the information and score relating to the second business relationship separately from the information and score relating the third party's first business relationship.

13. The system of claim 10, wherein the step of resolving the at least one finding further comprises:
verifying the answers from the series of questions relating to the risk associated with the business relationship with the third party received an online environment by conducting an onsite assessment.
generating at least one new score related to the risk associated with the business relationship with the third party based on the onsite assessment.

14. The system of claim 10, wherein the step of resolving the at least one finding further includes creating an exception, wherein the exception is a record a potential justification for difference between an answer given by a third party to one of the series of questions and a preferred answer.

15. The system of claim 10, wherein the at least one score generated is a plurality of scores and further wherein each of the plurality of scores is directed to a particular risk category related to the risk associated with the business relationship with the third party.

16. The system of claim 14, further comprising:
displaying the plurality of scores within a scorecard format wherein a first score for a particular category relates to a score generated through an online assessment, a second score for a particular category relates to a score generated through a onsite assessment, a third score for a particular category relates to an inherent risk, a fourth score relates to a residual risk and further wherein the scorecard format displays an improvement of the between original scores and current scores.

17. The system of claim 10, wherein each question of the series of questions relating to the risk associated with the business relationship with the third party is assigned a risk rating, and as findings are generated for particular answers given by the third party, the risk rating is transferred to the finding to indicate the criticality of the particular finding.

18. The system of claim 10, wherein one or more of the questions of the series of questions relating to the risk associated with the business relationship with the third party includes a plurality of choices from which the third party answering the question can choose one, several or all of the choices in its answer, further wherein the score is generated based, at least in part, on difference between the number of choices used in the third party's answer and the number of choices in the preferred answer.

19. A system comprising:
a network for integrating a plurality of modules in a system wherein the integration of the plurality of modules allows data to be shared between the modules; and
at least a first module including one or more computer-readable media storing computer-executable instructions which, when executed by a processor on a computer system, perform a method for determining a risk associated with a business relationship third party, wherein the method includes
identifying a potential third party for conducting a business relationship;
obtaining information about the third party wherein the information is answers to a series of questions relating to the risk associated with the business relationship with the third party;
generating at least one score related to the risk associated with the business relationship with the third party;
generating at least one finding about the risk associated with the business relationship with the third party if there is a difference between an answer to one of the series of questions and a preferred answer to that one of the series of questions;
resolving the at least one finding;
modifying the at least one score based on the resolution of the at least one finding; and
determining a risk based on the at least one modified score.

20. The system of claim 19, wherein the method performed by the first module further comprises alerting a compliance monitor that a compliance process has not been met when the system determines that one or more requirements of the compliance process have not been satisfied.
